(19) United States
(12) Patent Application Publication
(10) Pub. No.: US 2003/0103212 A1
(43) Pub. Date: Jun. 5, 2003

(54) Real-time imaging system and method

(76) Inventors: Volker Westphal, Hannover (DE); Andrew M. Rollins, Highland Heights, OH (US); Rujchai Ung-Arunyawee, Amphur Lamlukka (TH); Joseph A. Izatt, Raleigh, NC (US)

Correspondence Address: Warren A. Sklar, Renner, Otto, Boisselle & Sklar, LLP, 19th Floor, 1621 Euclid Avenue, Cleveland, OH, 44115-2191, US

(21) Appl. No.: 10/212,364

(22) Filed: Aug. 5, 2002

Related U.S. Application Data
(60) Provisional application No. 60/310,082, filed on Aug. 3, 2001.

(51) Int. Cl. G01B 9/02

(52) U.S. Cl. 356/479

(57) ABSTRACT

Software techniques that are used for real-time imaging in OCT (Optical coherence tomography), particularly for correcting geometric and angular image distortions. In addition, a methodology for quantitative image correction in OCT images includes procedures for correction of non-telocentric scan patterns, as well as a novel approach for refraction correction in layered media based on Fermat's principle.

Applicants claim the benefit of U.S. Provisional Application No. 60/310,082 filed Aug. 7, 2001, the entire disclosure of which is hereby incorporated herein.

### FIELD OF THE INVENTION

The present invention is directed to a real-time imaging system and method that is particularly useful in the medical field, and more particularly, to a system and method for imaging and analysis of tissue using optical coherence tomography.

### BACKGROUND OF THE INVENTION

A variety of imaging techniques are used for the medical diagnosis and treatment of patients. Ultrasound imaging represents a prevalent technique. Ultrasound uses sound waves to obtain a cross-sectional image of an object. These waves are radiated by a transducer, directed into the tissues of a patient, and reflected from the tissues. The transducer also operates as a receiver to receive the reflected waves and electronically process them for ultimate display.

Another imaging technique is referred to as Optical Coherence Tomography (OCT). OCT uses light to obtain a cross-sectional image of tissue. The use of light allows for faster scanning times than occurs in ultrasound technology. The depth of tissue scan in OCT is based on low coherence interferometry. Low coherence interferometry involves splitting a light beam from a low coherence light source into two beams, a sampling beam and a reference beam. These two beams are then used to form an interferometer. The sampling beam hits and penetrates the tissue, or other object, under measurement. The sampling or measurement beam is reflected or scattered from the tissue, carrying information about the reflecting points from the surface and the depth of tissue. The reference beam hits a reference reflector, such as, for example, a mirror or a diffraction grating, and reflects from the reference reflector. The reference reflector either moves or is designed such that the reflection occurs at different distances from the beam splitting point and returns at a different point in time or in space, which actually represents the depth of scan. The time for the reference beam to return represents the desirable depth of penetration of tissue by the sampling beam.

When the reflected beams meet, intensities from respective points with equal time delay form interference. A photodetector detects this interference and converts it into electrical signals. The signals are electronically processed and ultimately displayed, for example, on a computer screen or other monitor.

### SUMMARY OF THE INVENTION

The present invention provides a system and method for overcoming or minimizing the problems of prior optical coherence tomography systems and improving on other imaging methodologies. Software techniques that are used for real-time imaging in OCT (Optical coherence tomography), particularly for correcting geometric and angular image distortions. In addition, a methodology for quantitative image correction in OCT images includes procedures for correction of non-telocentric scan patterns, as well as a novel approach for refraction correction in layered media based on Fermat's principle.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

### BRIEF DESCRIPTION OF THE DRAWINGS

FIG. 1 is a timing diagram for double-sided line acquisition.

FIG. 2 is a mapping array used in backward transformation.

FIG. 3 is an example of inserted zoom realized with mapping arrays in real-time.

FIG. 4 is a flow chart for the determination of whether a pixel is displayed as a structural or flow value.

FIG. 5 illustrates an exemplary non-linear scanning.

FIG. 6.1 is an OCT system in accordance with the present invention illustrating components and synchronization. The thick lines represent optical signals, dash lines represent electronic signals, and thin lines represent synchronization signals.

FIG. 6.2 schematically illustrates optical power-conserving interferometer configurations.

FIG. 6.3 is a timing diagram for OCT synchronization electronics.

FIG. 6.4 is a block diagram of an endoscopic OCT (EOCT) system. Light from a high-power broadband source is coupled through an optical circulator to a fiber-optic Michelson interferometer. The EOCT catheter probe and probe control unit constitute one arm of the interferometer, and a rapid-scanning optical delay line constitutes the other arm. The gray lines represent optical paths and black lines represent electronic paths.

FIG. 6.5 is a block diagram of a simple frame grabber. Video signals can be either composite or non-composite. External sync signals are selected by the acquisition/window control circuitry.

FIG. 6.6 signal components (normal) and input controls (italics) of the horizontal video signal.

FIG. 6.7 signal components (normal) and input controls (italics) of the vertical video signal.

FIG. 6.8 plot of the retinal false-color scale represented in RGB color space. Green and blue color values are identical between 209-255 pixel values.

FIG. 6.9 comparison of an in vivo human retinal OCT image along the papillomacular axis represented in a) linear grayscale, b) inverse linear grayscale, and c) retinal false-color scale (with labels).

FIG. 6.10 is a one-dimensional forward and inverse mappings.

FIG. 6.11 illustrates image rotation transformation.

FIG. 6.12 illustrates rectangular to polar coordinate transformation.

FIG. 6.13 is a timing diagram for double-sided line acquisition.

FIG. 6.14 is a motion artifact reduction by cross-correlation scan registration. Patient axial motion during the original retinal image (a) acquisition was estimated from a profile built up from the peak of the cross-correlations of each A-scan with respect its neighbor (b). The resulting profile is then high-pass filtered to preserve real retinal profile, and used to re-register each individual A-scan in the image (c).

FIG. 6.15 is a schematic of systems theory model for OCT.

FIG. 6.16 is an example of digital deconvolution of low-coherence interferometry data.

FIG. 6.16a is an observed interferogram of a cover slip resting on a piece of paper.

FIG. 6.16b is an interferogram obtained with a mirror in the sample arm.

FIG. 6.16c is a deconvolved impulse response profile.

FIG. 6.17 illustrates original (a) magnitude-only deconvolved (b) and iteratively deconvoled (c) cross-sectional OCT images revealing cellular structure in a onion sample. Both deconvolutions resulting in a resolution increased by a factor of approximately 1.5 or approximately 8 micrometers FWHM resolution in the deconvolved images, although the iterative restoration algorithm preserved image dynamic range significantly better.

FIG. 6.18 is an illustration of coherent OCT deconvolution. In the top image, the magnitude and phase of a demodulated OCT A-scan data obtained from two closely spaced glass-air interfaces with slightly distinct separation, results in (a) destructive (note 180° phase shift at the mid-point) and (b) constructive interference between the reflections. In the middle images, deconvolution of the A-scan data performed using only the magnitude of the input data, leads to inaccurate positioning of reflections and spurious reflections in the calculated impulse response. In the bottom image, complex deconvolution recovers the true locations of the interfaces in both cases and thus enhances resolution by a factor of approximately 1.5, as well as reducing speckle noise.

FIG. 6.19 is a demonstration of depth-resolved OCT spectroscopy in a discrete optical element. The spectral transfer characteristic |H(k)|² of the light reflected from 1) the front surface and 2) the rear surface of a commercial interference filter (IF) are plotted. Both spectra were obtained by digital processing of windowed OCT A-scans of the filter. The measured spectral widths correspond well with the manufacturer's specifications (SLD spectral width 47 nm FWHM; filter bandwidth nm FWHM).

FIG. 6.20 is a table of useful spatial transformation (point-set operation) matrices.

FIG. 7 is an illustration of using a pointer array as a mapping array to allow for fast backward transformation.

FIG. 8 is an illustration for correction for sinusoidal scanning.

FIG. 9 illustrates correction for divergence.

FIG. 9a indicates coordinates and measures in the intermediate image, and b) provides the same for the target image.

FIG. 10 illustrates a path of light through different layers of tissue, refracted at the points P_{b1} and P_{b2}. L=L₁+L₂+L₃ should be minimized to find the right path.

FIG. 11 includes a series of OCT images of the temporal anterior chamber angle of a human eye, imaged in vivo at 8 fps, in different stages of dewarping.

FIG. 11a is a raw image.

FIG. 11b illustrates removal of nonlinear reference mirror movement, FIG. 11c illustrates divergence correction of a handheld scanner, FIG. 11d correction for refraction at the air-cornea boundary (n_{cornea}=1.38), FIG. 11e additionally corrects for refraction at the endothelium-aqueous boundary (n_{acqueous}=1.33).

FIG. 12 is a slide showing a mapping array.

FIG. 13 is a slide illustrating sinusoidal dewarping.

FIG. 14 is a slide illustrating correction of nonlinear scan speed.

FIG. 15 is a slide illustrating the result of a correction.

FIG. 16 is slide illustrating divergence correction.

FIG. 17 is a slide illustrating refraction at interfaces.

FIG. 18 is a combination of all techniques showing the images which can be achieved.

FIG. 19 is a slide illustrating inserted zoom.

FIG. 20 is a slide illustrating temporal average and speckle reduction.

FIG. 21 illustrates an overlay technique.

FIG. 22 is a flow chart illustrating the overlay technique.

FIG. 23 illustrates OCT images of the temporal anterior chamber angle of a human eye, imaged in vivo at 8 fps in different stages of dewarping.

FIG. 23a (i) is an image of an Intralipid© drop on a coverslip. Notice the bending of the flat slip surface and the bump well below the drop.

FIG. 23a (ii) illustrates a corrected image with a flat surface and no bump, FIG. 23b is a raw image and FIG. 23c illustrates divergence correction of a handheld scanner and FIG. 24d illustrates the image of 24b corrected for refraction at the air-cornea boundary (n_{cornea}=1.38) and at the endothelium-acqueous boundary (n_{acqueous}−1.33).

FIG. 24 is a sequence of images illustrating the image correction.

### DETAILED DESCRIPTION

### REAL-TIME IMAGING AND IMAGE PROCESSING DISCLOSURE

In this section, we demonstrate and explain software techniques that are used for real-time imaging in OCT (Optical coherence tomography). Special attention is given to image processing methods that correct geometric and angular image distortions. Examples are geometric distortions due to the applied scanning configuration, nonlinear scanner movements and refraction. Polar scanning configurations, useful for endoscopy are treated. We are able to practice both online and offline processing, because we are able to save the complete acquired digital data. A special history function greatly simplifies and sometimes enables to save the best images for documentation and later processing.

1 Image Transformations, Corrections of Nonlinearities, Achieving Geometrical and Angular Correct Images

For display, P′=(x′,y′) in the acquired data, the raw image, has to be transformed into P=(x,y) in the target image. In principle, this can be done in forward (P=f(P′)) or backward (P′=F(P)) direction. For forward mapping the target position for a given data point is calculated. This has a key disadvantage: Since the target position will most likely be between target pixels, sophisticated algorithms have to be applied to distribute its value onto the neighboring pixels to prevent dark spots and ambiguous assigned pixels, which leads to a high computational expense. Backward mapping avoids this disadvantage by mapping each target pixel to a location in the acquired image, then using simple interpolations to obtain its value. If the backward transformation is fixed, it can be implemented with lookup table to achieve real-time imaging (Sect. 2). In the raw image, x′ and y′ denote the coordinates across and along A-scans (single depth scans). To obtain the brightest possible images with OCT, the field of view with a physical width w and depth d is centered a focal length f away from the lens on the optical axis. The size of the raw (data) and target (display) image is n′×m′ (h×v) and n×m, respectively. The backward transformation, separated in both coordinates, is denoted as

x′=Fₓ(x,y)

y′=F_{y}(x,y) (1)

1.1 Correct Aspect Ratio

Often the width and height of acquired data points, given in physical dimensions they represent, are not equal. Direct mapping of this raw data acquired on the screen would lead to the wrong aspect ratio in display. The following transformations correct this:

$${F}_{aspect , x} ( x , y ) = \frac{{n}^{′}}{n} x \\ {F}_{aspect , y} ( x , y ) = \frac{{m}^{′}}{m} y \qquad ( 2 )$$

with the condition that the target image has the correct aspect ratio

$$m = n \frac{d}{w} . \qquad ( 3 )$$

1.2 Bidirectional Scanning

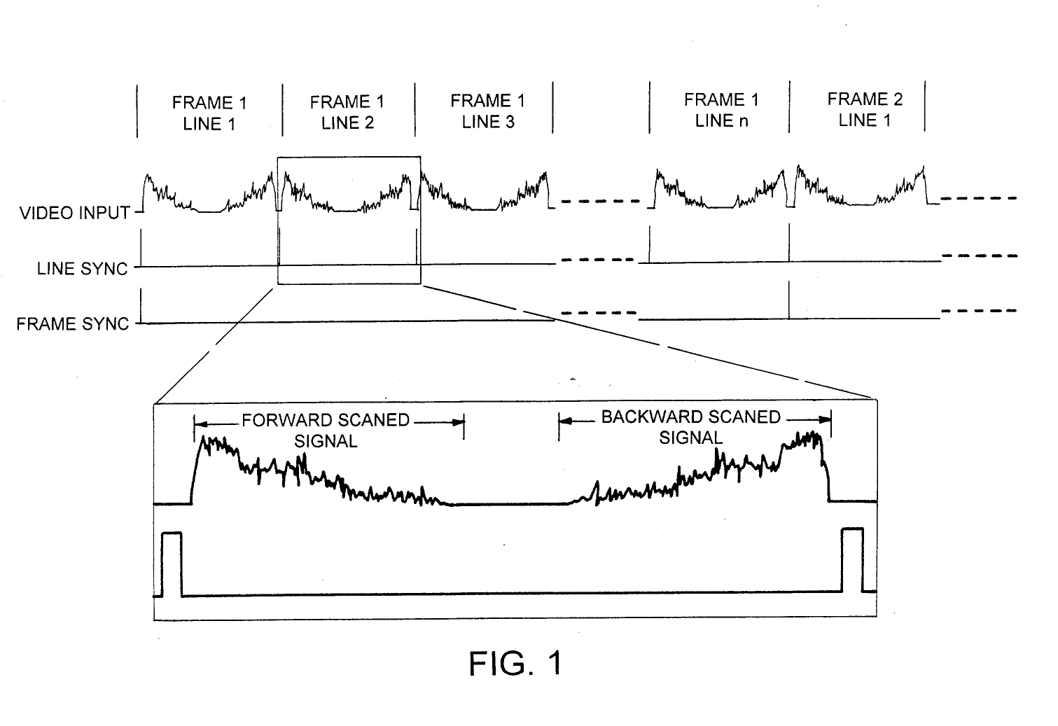

When an OCT system utilizes double-sided scanning (i.e., A-scan acquisition during both directions of the reference arm scan), a transformation is necessary to rectify the alternate, reversed A-scans (FIG. 1). Again, a static backward transformation can be formulated to transform the acquired image array into the image array to be displayed.

$${F}_{bidirect , x} ( x , y ) = \{ \begin{matrix}x / 2 & if round ( y \frac{m}{d} ) is even \\ - x / 2 & else\end{matrix} \\ {F}_{bidirect , y} ( x , y ) = y / 2 \qquad ( 4 )$$

F_{bidirect,y}(x,y)=y/2

With bidirectional acquisition (see also Sect. 1.3 and 3.1) and a duty cycle η lower 100%, there ‘dead’ pixels acquired between the end of the forward and the begin of the backward scan, which have to be omitted in Eq. (4). This correction will be simplified if the duty cycle is center in the physical forward and backward scan. Compare also: “Chapter 6. System Integration and Signal/Image Processing”, Sect. 6.2.2.1.5

1.3 Registration

When implementing double-sided scanning correction, it is necessary that consecutive A-scans are registered with respect to one another. Depending upon the OCT system configuration, the scan registration may be accomplished by adjusting the delay line optics. In a clinical setting, however, where the hardware is closed, it may be more desirable to implement a software registration mechanism. This could be accomplished by allowing manual adjustment by the operator, or by an automatic registration algorithm. A simple way, without computational expense, is to change the position of the start pixel of the acquired scan on the framegrabber card within the window of a comlete linescan. Because this shifts the position of the forward and the backward scan by 1 pixel, the registration can only be done with an accuracy of 2 pixels. Fine adjustments result in changes in the backward transformation, which can be precalculated in the mapping array (Sect. 2). Algorithms for automatic registration will be discussed in Sect. 3.1).

1.4 Transpose

Raw images are normally acquired A-scan per A-scan with a framegrabber, forming line by line in the raw image. The columns in the raw image represent different depths. For display, subsequent A-scan form column by column on the screen, a transpose operation is therefore necessary:

F_{transpose,x}(x,y)=y

F_{transpose,y}(x,y)=x (5)

In a similar way, arbitrary rotations are possible.

1.5 Polar Image Transformation

This technique is used in combination with a rotational scanning probe (e.g. an endoscopic probe). With this probe A-scans are taken in a radial fashion, with the probe constantly rotating. Therefore x′ and y′ are rather polar coordinates:

$$R ( {x}^{′} ) = \frac{{x}^{′}}{{n}^{′}} + \frac{{r}_{probe} + \frac{d}{2}}{d} \\ θ ( {y}^{′} ) = 2 π \frac{{y}^{′}}{{m}^{′}} \qquad ( 6 )$$

with the radius r_{probe} of the probe and the imaging depth d. R and θ are dimensionless. They can also be expressed in target coordinates

$$R ( x , y ) = \frac{\sqrt{{x}^{2} + {y}^{2}}}{n / 2} \frac{{r}_{probe} + d}{d} \\ θ ( x , y ) = arctan ( \frac{y}{x} ) \qquad ( 7 )$$

By combining Eq. (6) and (7) the backward transformations can be obtained

$${F}_{radial , x} ( x , y ) = ( \frac{\sqrt{{x}^{2} + {y}^{2}}}{d / 2} \frac{{r}_{probe} + d}{d} - \frac{{r}_{probe} + \frac{d}{2}}{d} ) d \\ {F}_{radial , y} ( x , y ) = \frac{{w}_{rad}}{2 π} arctan ( \frac{y}{x} ) \qquad ( 8 )$$

with w_{rad} the circumference length of the acquisition. Compare also: “Chapter 6. System Integration and Signal/Image Processing”, Sect. 6.2.2.1.4 and “Multistep image dewarping of OCT images using Fermat's principle and mapping arrays”, Sect. 1.2.

1.6 Correction of Nonlinearities in Scanning Mirror Movements

An acquired OCT image will be warped if the spatial distribution of the acquired data does not directly correspond to the spatial distribution of scattering profile of the sample. This occurs in OCT imaging when the image data is not sampled at regular intervals in space. For example, if the scanning motion of the OCT probe or delay line is not linear with time, and the data is sampled at regular intervals in time, then the image will be warped. If the scan nonlinearity is a known function of time, however, the image can be ‘de-warped’ by an appropriate spatial transformation. This is the case, for example, for the sinusoidal motion of a resonant scanning device. In this case, the coordinate corresponding to the resonant scanner can be transformed by a sinusoidal function with a period corresponding to the period of the scan in image space. Alternatively, if an accurate reference signal is available, a corresponding sampling trigger signal could be generated to sample nonlinearly in time such that the image is sampled linearly in space. This latter technique is common in Fourier transform spectrometers, and has previously been applied in high-accuracy interferogram acquisition in OCT. In this disclosure we propose a method to dewarp the image accurately after acquisition using the position sensor information recorded before OCT imaging. This correction of image distortions due to scanner nonlinearities works in both, cross-sectional imaging (like in standard OCT) and in en face imaging (like in OCM (optical coherence microscopy) or scanning confocal microscopy).

1.6.1 Fast Axis Scan

The fast axis scan is the most likely to show nonlinearities in the scan. When moving or turning a mirror at a fast pace effects of momentum and inertia prevent the control electronics of the scanner to regulate the scanner position exactly to the sawtooth or triangular driving waveform used as command voltage for linear scans. But normally scanners (galvanometers) provide a position sensor output with can be sampled into the framegrabber input (either instead of the OCT signal or into a different input of the framegrabber). Gain and offset of the framegrabber have to be adjusted to have the sensor input to almost fill but not overfill the framegrabber input voltage range. Than for each pixel position in the A-scan the corresponding physical position in the sample, given by the sensor output, can by recorded. Assuming that the nonlinearities are repetitive between subsequent scans, averaging the position values for more than a hundred A-scans reduces the noise by a factor of the square root of the number of scans. The standard deviation gives the confidence assigned to this position detection. Let's assume an A-scan consists out of m′ pixels at the time positions y′i, having position values p′ᵢ. The p′ᵢ are centered around zero, with an amplitude of ±Δp. For the backward transformation F_{sensor,y}(x,y) the algorithm looks for position y′_{i,min} with the minimum p′_{i,min} and the position y′_{i,max} with the maximum p′_{i,max}. With this data set the reverse transformation can be calculated from the reverse interpolation (e.g. linear or spline)

$${F}_{sensor , y} ( x , y ) = Interpolation ( {p}_{i}^{′} \frac{d}{2 Δ p} , {y}_{i} , y ) \qquad ( 9 )$$

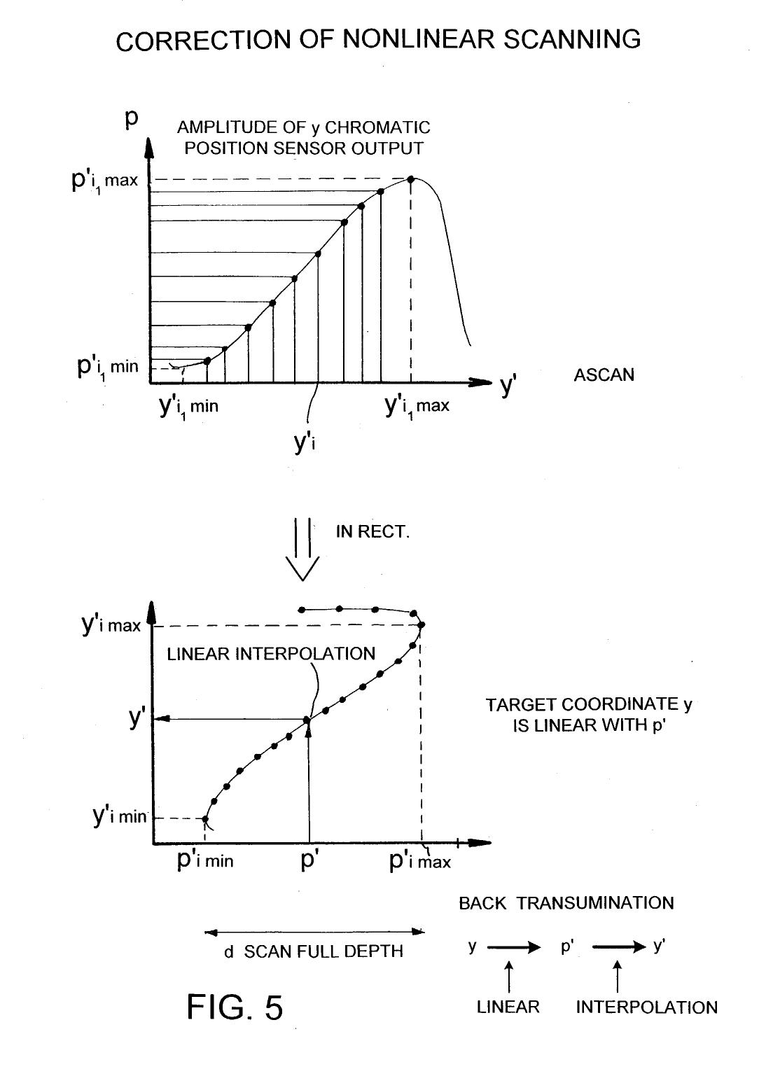

with p′ᵢlimited to (p′_{i,min} . . . p′_{i,max}) and y′ᵢ limited to (y′_{i,min} . . . y′_{i,max}). See FIG. 5. B=Interpolation (AA,BB,A) uses the input vectors AA and BB to estimate the value B for the position A.

If the fast axis scanner is used for carrier frequency generation, then strong nonlinearities, that can be corrected position wise lead to strong changes in the carrier frequency. Therefore either the first bandpass limiting the detectable signal bandwidth has to be opened up to pass those wider range of signal frequencies (at the expense of SNR), tracking filters or tracking local oscillators have to be used to adapt the current bandpass center frequency to the center carrier frequency or a phase modulator for constant center frequency have to employed.

1.6.1.1 Special Case: Resonant Mirror

For fastest scanning only resonant mirrors can be employed, with scan frequencies of several kHz, necessary for real-time OCT imaging. When using a high duty cycle of 50% or higher, the scan becomes more and more nonlinear. Because of the operation in the resonance mode, the scan follows very exactly a sinusoidal pattern. With this knowledge the backtransformation can be determined without measuring the position waveform.

The raw image is captured with n′ pixels per A-scan and m′ A-scans. In principle there would be n′ₚₚ pixel (peak to peak) available in an A-scan, therefore the duty cycle η is defined as

$$η = \frac{{n}^{′}}{{n}_{pp}^{′}} \qquad ( 10 )$$

The forward transformation from raw (x′,y′) into target (x,y) coordinates is defined as

$$x ( {y}^{′} ) = {y}^{′} \frac{n}{{m}^{′}} \\ y ( {x}^{′} ) = \frac{{m}_{pp}}{2} sin ( \frac{2 π}{2 {n}_{pp}^{′}} x ) \qquad ( 11 )$$

with the full peak to peak amplitude m′ₚₚ of the A-scan in the intermediate coordinates Because η<100% only part of the full sinusoidal motion is visible, the intermediate image span mᵢ pixel in depth. mₚₚ can be calculated from

$$\begin{matrix}y ( \frac{{n}^{′}}{2} ) = \frac{{m}_{pp}^{′}}{2} sin ( \frac{π}{{n}_{pp}^{′}} \frac{{n}_{r}}{2} ) = \frac{m}{2} ⇒ \\ {m}_{pp}^{′} = \frac{m}{sin ( \frac{π}{2} η )}\end{matrix} \qquad ( 12 )$$

Therefore the back-transformation will be as follows

$$\begin{matrix}{F}_{sinus , x} ( x , y ) = \frac{{n}_{pp}^{′}}{π} arcsin ( \frac{2 y}{{m}_{pp}^{′}} ) \\ {F}_{sinus , y} ( x , y ) = x \frac{{m}^{′}}{n}\end{matrix} \qquad ( 13 )$$

See also “Multistep image dewarping of OCT images using Fermat's principle and mapping arrays”, Sect. 2.

1.6.2 Slow Axis Scan

Although less obvious, the scanning nonlinearities in the slow axis scan can be corrected similarity to Sect. 1.6.1.

1.7 Correction of Geometric Errors Due to Scanning Configuration

Depending of where the scanning pivot is located in respect to the final lens (focusing the light into the tissue) different scanning regimes can be defined. This different regimes can be distinguished into converging, telecentric and diverging scanning configurations. Diverging and converging scanning configuration lead to geometric image distortions, because the field of view is not rectangular. For this disclosure we propose a transformation to correct this distortion. This math is described in “Correction of image distortions in OCT based on Fermat's principle”

2 Mapping Array

A mapping array has the same dimensions as an expected output image. This array represents the point set of an output image in which each element contains the location of an input pixel. With the mapping array, the value set of the output image can be obtained by backward mapping to the input image. In a software implementation of image transformations, the required mapping array needs to be created only once and stored in memory. This approach minimizes computation time while imaging as compared to iterative formula-based calculation of image transformations in real-time. Every static image transformation can be formulated with this lookup technique, e.g. the correction of the aspect ratio (Sect. 1.1), bidirectional scanning (Sect 1.2), registration (Sect. 1.3), transposition and arbitrary rotation (Sect 1.4), polar image transformation (Sect 1.5), correction of nonlinearities in scan mirror movements (Sect. 1.6) and the correction of geometric errors due to scanning configurations (Sect 1.7). Because all methods are based on backward transformations, they can be cascaded, e.g. combining bidirectional scanning with the correction of nonlinearities of scanner movements and correction of geometric errors due to the scanning configuration:

F_{total,x,y}(x,y)=F_{geometric,x,y}(F_{scanner,x,y}(F_{bidirect,x,y}(x,y))) (14)

with this being a shorthand for the transformations in x and y.

The mapping array consists of pointers ptr(x,y) that point to the direct memory location of the raw data, here given for the next neighbor interpolation.

ptr(x,y)=Raw_data_start_address+round(F_{total,x}(x,y))+round(F_{total,y}(x,y))*bytes_per_line (15)

When data is to be displayed the gray value g(x,y) at the target pixel (x,y) is given by

g(x,y)=*ptr(x,y) (16)

where ‘*p’ denotes the access to the byte where p is pointing to.

2.1 Inserted Zoom

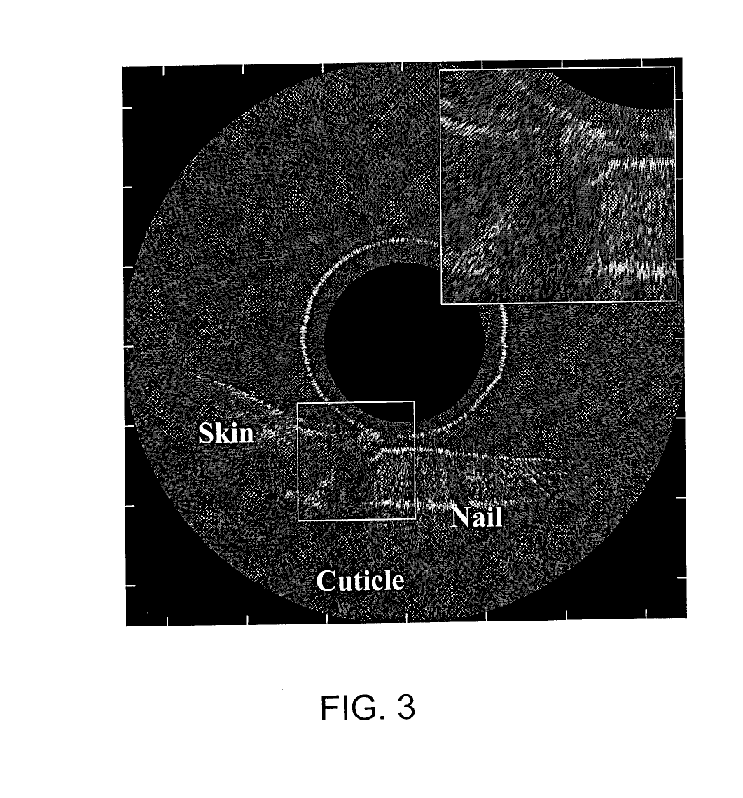

The mapping array is also capable of real-time zooming of a given window, with no penalty in image transformation time. To achieve that, a certain portion (e.g. the upper right quadrant,“zoom target”) is reserved for the online zoom. Second, is small rectangle (“zoom source”) is defined somewhere else in the image, smaller than the zoom target. Now the pointer defined in the zoom target are replaced by pointers that point into the raw data for pixels in the zoom source. Since the zoom target in bigger than the zoom source, the raw data is sampled finer than in the rest of the image (FIG. 3). Since the zoom data is resampled, not just blown up, details that previously were being hidden, become visible. This is especially true, when the source image is bigger than the target image, or due to strong nonlinearities in the transformation many source pixel are hidden. An example for that is the polar transformation, where close to the probe many raw data points are not shown (FIG. 3).

2.2 Interpolation

When doing the backward transformation, the pixel location for the data requested in the raw image will be not an integer position. The fastest method to do the interpolation is the “next neighbor” interpolation, which just rounds the source pixel location to the next integer position. This method is lossy and generates a blocky target image appearance, especially for higher zooms. A better method is using the bilinear interpolation which is more computational expensive. We propose a method to optimize this method to still allow real-time imaging. Each entry ptr(x,y) in the mapping array is therefore extended by 4 bytes w₁ to w₄ with the relative weight of the neighboring four pixel, coded in the range of 0 . . . 255. The target of the ptr(x,y) is always rounded down with the floor( ) operation.

ptr(x,y)=Raw_data_start_address+floor(F_{total,x}(x,y))+floor(F_{total,y}(x,y))*bytes_per_line (17)

When data is to be displayed the gray value g(x,y) at the target pixel (x,y) is given by

$$g ( x , y ) = ( \begin{matrix}* ptr ( x , y ) * {w}_{1} + \\ * ( ptr ( x , y ) * {w}_{2} + \\ * ( ptr ( x , y ) + bytes\_per \_line ) * {w}_{3} + \\ * ( ptr ( x , y ) + bytes\_per \_line + 1 ) * {w}_{4}\end{matrix} ) shr 2 \qquad ( 18 )$$

shr 2 devides by 4 (but is faster) and normalizes the range of g back to the original range of the raw data.

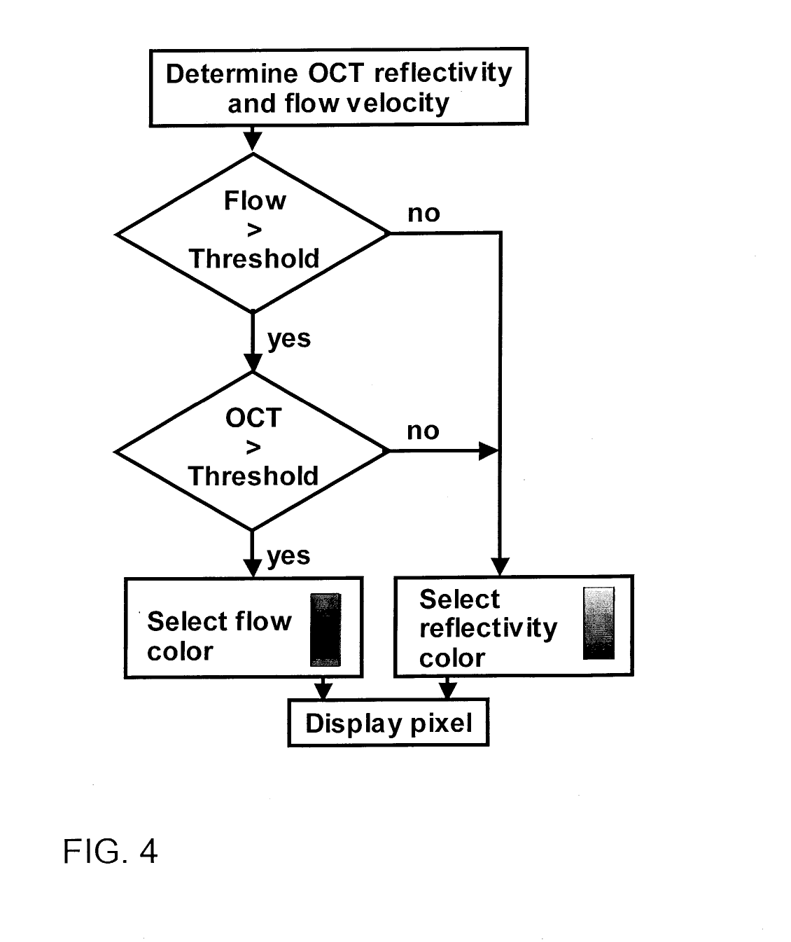

For real-time color Doppler display we combine our standard mapping array with all its advantages with a second lookup table. The data sampled for the structural image is bytewise interleaved with the flow data, forming 16 bit values of data containing all information for a data point. To display a pixel as a flow value, two conditions have to be met: (1) the flow must exceed a threshold and (2) the value of the structural image at this point has to be high enough to validate the presents of blood, which is highly scattering at 1300 nm. FIG. 4 shows the flow chart for this decision process. Checking these two conditions while displaying would be too computational expensive for real-time display. But by precalculating a lookup table for the resulting color for all possible combinations of structural and flow value, this decision process is reduced to a simple memory access by using the 16 bit value of the combined structural and flow value as a pointer into this lookup table.

3 Online Image Processing

We implemented a couple of other important online processing methods to improve image quality.

3.1 Autoregistration

When using bidirectional scanning, the forward and backward scan have to be carefully registered to achieve a sharp image. The easiest way to implement the registration is by user input. Unfortunately, the registration has to be readjusted about every 5-10 minutes of imaging, due to small instabilities in the linesync generation. Manual registration is been complicated by the fact that the human observer only can detect that the image gets ‘fuzzy’, but not clear in which direction to change the registration without trying. Secondly, in a moving sample it is difficult to correctly see any small misregistration. An example is endoscopic imaging: In air, the outer sheath can act as a reference line for registration, but inside the patient this reflection vanished due to tissue contact and variable amounts of fluid on the probe.

To address this problem, we propose utilizing the reflection at an unaffected surface like the inner sheath surface of the endoscopic probe or if a glass plate is present in the sample arm, using the back surface of this glass plate. Since this reference surface is always the same distance away, we can form an average forward and an average backward scan, limited to the depth range, where the reference line is expected. The computer than calculates the cross-correlation function for a full range of different lag and changes the registration to achieve maximum cross-correlation at zero lag. To prevent oscillations, this is done only every few images with following algorithm: If the calculated maximum lag is big, the next registration step will reduce to the half. If the cross-correlation has its maximum close to zero lag, the registration will be only change by the smallest possible step. Experiments showed that within seconds the registration reached its best point and stayed there.

3.2 Running Average With Lateral Registration

To improve the SNR and to reveal details deeper into the tissue we applied an averaging technique to subsequent images. This was implemented as a running average to sustain real-time imaging

Sₙ=Sₙ₋₁+Iₙ−Iₗ₋ₐ

Dₙ=Sₙ/a (19)

with the n^{th} sum Sₙ, the n^{th} image acquired Iₙ, the n^{th} displayed image Dₙ, and the running average length a. Lateral motion artifacts were strongly reduced by lateral registration through cross-correlation of lateral stripes of 20 pixel in depth in a imaging where sample signal is to be expected.

3.3 Online Detection of Front Surface

For depth gain compensation and correction of the index of refraction, as well as correction of refraction, it is useful to online detect the topmost surface of the sample, because there the absorption and index of refraction changes dramatically at this boundary. We accomplished this detection by using following steps

Gaussian filter of with a larger axial size than lateral size.

Edge detection with a axial Sobel filter with the length of the axial Gaussian filter.

look for the maximum in the edge image axial every 30 A-scans.

Use this points as starting points for active contours.

3.3.1 Correction of Index of Refraction Below Surface With Dynamic Mapping Array

Since OCT measures the optical pathlength rather than the physical distance, OCT images taken in air are distorted in a way that the tissue layers appear thicker than they are. This error is most obvious with samples that have wavy surfaces, like skin with dermal ridges. These waves will have artifacts in deeper layer structures, disturbing the diagnosis (Refraction is another issue that will be discussed in Sect. 5.1). We purposes here the application of a mapping array with a dynamic added 1D overlay. This overlay is chosen depending on the axial position in which the surface was detected in this A-scan and the index of refraction and allows real-time display with correction of index of refraction.

3.3.2 Depth Gain Compensation

The strength of the OCT signal degrades exponentially with depth. Since usually the OCT signal is displayed on an exponential scale on the screen, this means, the intensity in gray values drops linearly from the depth of the scan where it hits the surface. It the top surface is known, a linearly with depth growing offset can be added to the OCT signal to compensate for the loss. This is limited by the amplification of noise outside the tissue

4 Streaming, Online Documentation

The standard procedure before streaming was to have a live display, and when an image with relevant content appears, to freeze the display and save this image. Alternative the screen output is recorded to S-VHS. Both approaches have strong disadvantages. When the feature of interest was only transient on the screen, freezing was maybe to slow to keep the image, it is then lost. Recording on VCR reduces the image quality dramatically. We propose to record the complete raw digital data to harddrive while imaging (as a stream of data). This approach has several advantages

retaining the full, complete raw data allow for offline processing the data which algorithms not available in real-time.

Zooming in post-processing shows data not visible during live imaging (c.f. Sect. 2.1)

The frames of a stream are appended to an expanding multiple TIFF-file. TIFF is a very flexible structure, which also allows for storage of additional information with the images, like patient and study information, acquisition parameters, labels and tissue identifications and classifications

When saving as a multiple TIFF, streaming of all acquired images into a circular buffer (called the history buffer) for the images worth 10-20 s. We propose this circular buffer as a very useful tool to retrieve good images and low load on the hard drive capacity. After freezing the acquisition the user has access to all images of the last 10 to 20 sec with hotkeys or by mouse selection. Functions available are going framewise forward or backward in the history, cyclic playing of the history images. There is a function to save the currently displayed frame or all frame from this history buffer. Hotkeys can be associated with VCR like keys as easy mnemonics. Before saving images can be classified, the visible organ with shortcut buttons or typing specified, features visible can be labeled onscreen with an overlaying label (nondestructively). All this extra information will be saved within single TIFF's. Alternatively, all single images, save history buffer, and direct streaming will be saved in one file. The idea is to have one file per procedure or patient, for easy documentation. All images have a timestamp with a resolution of ms saved with it for easy and unique identification.

5 Offline Image Processing

Since we save the complete raw digital data acquired, we can do offline processing without any losses, with the advantage of being able to do computational intensive calculations to improve image quality and feature visibility

5.1 Correction of Index of Refraction

cf. Correction of image distortions in OCT based on Fermat's principle

5.2 Offline Registration

Even though automatic registration of forward and backward scans during processing works reasonable well, best results are obtainable by human intervention in post processing, aligning it to a half a pixel precision

5.3 Stream View

To handle the huge amount of images

1 line/frame

Info 1 and 2 on both sides and short bars in the middle for fast orientation

### SYSTEM INTEGRATION AND SIGNAL/IMAGE PROCESSING

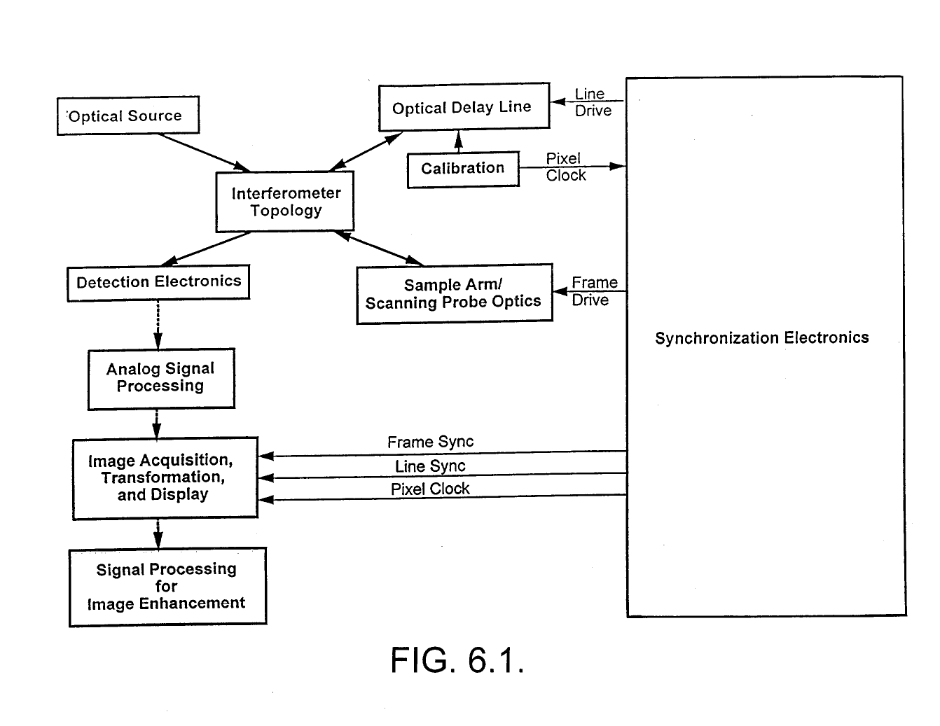

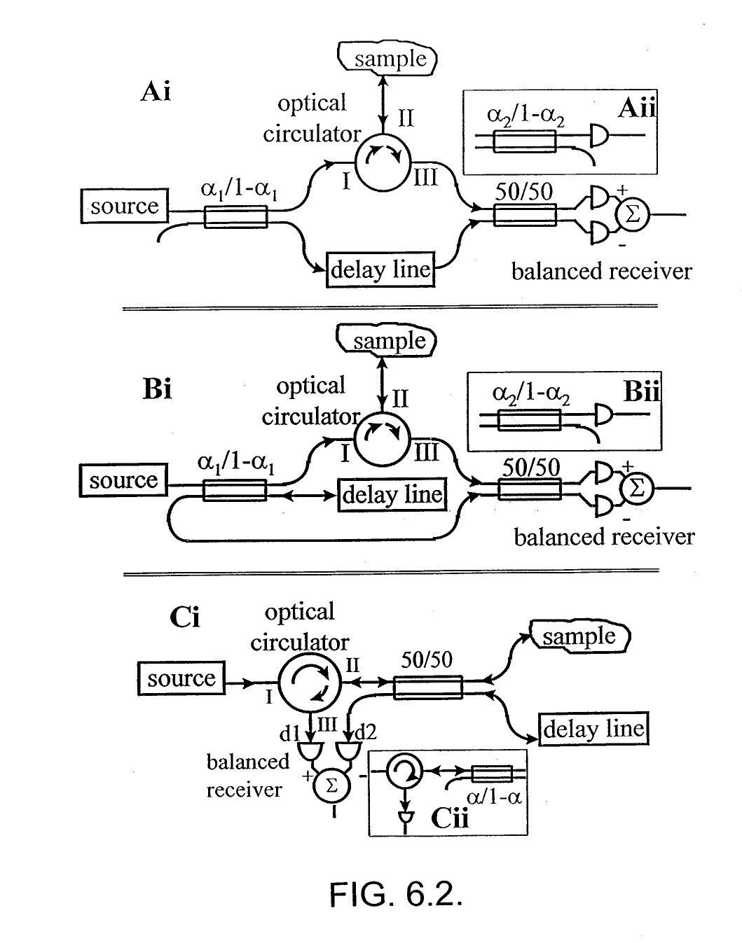

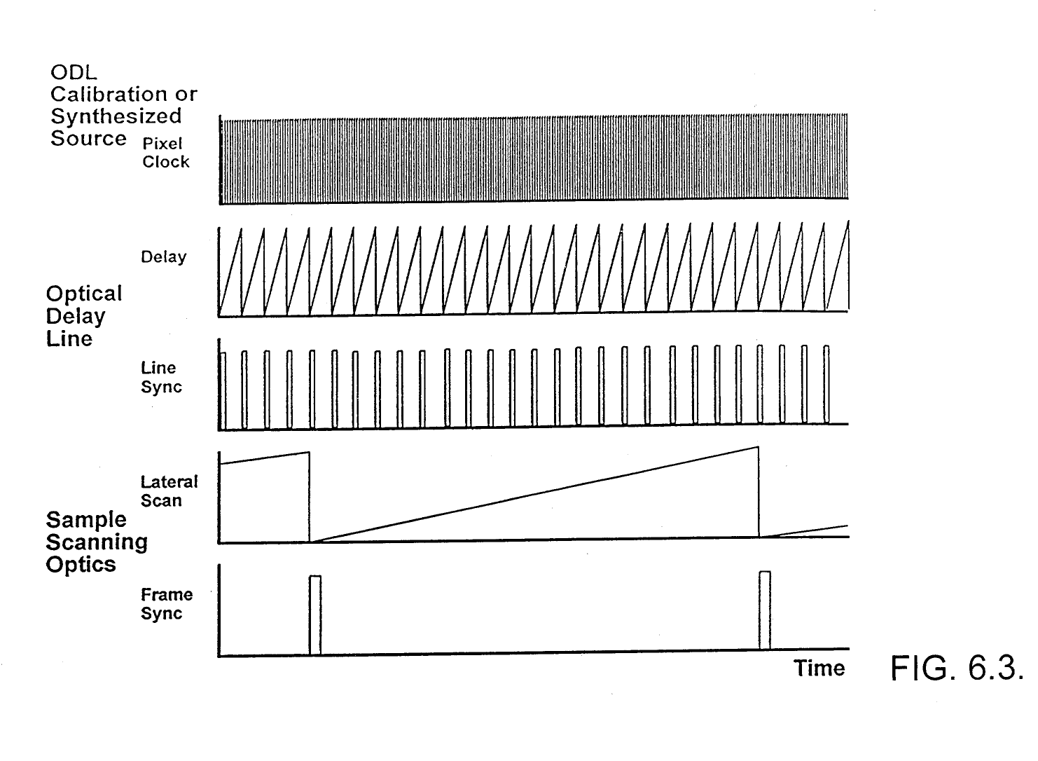

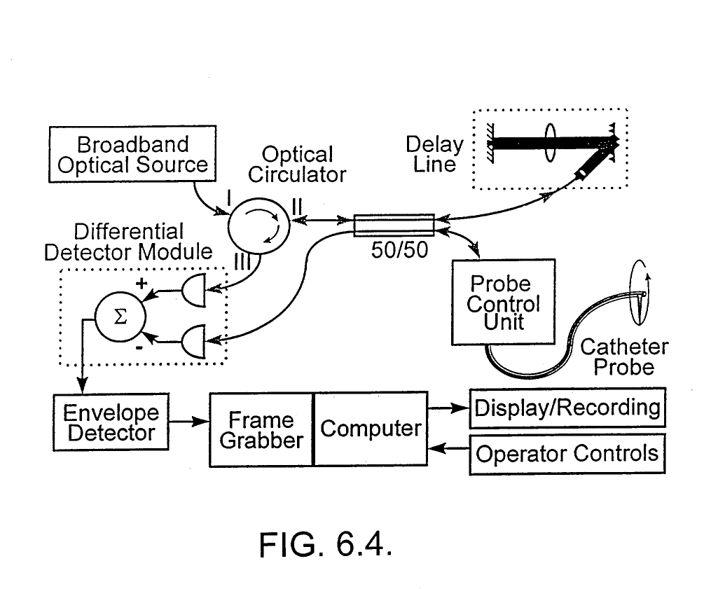

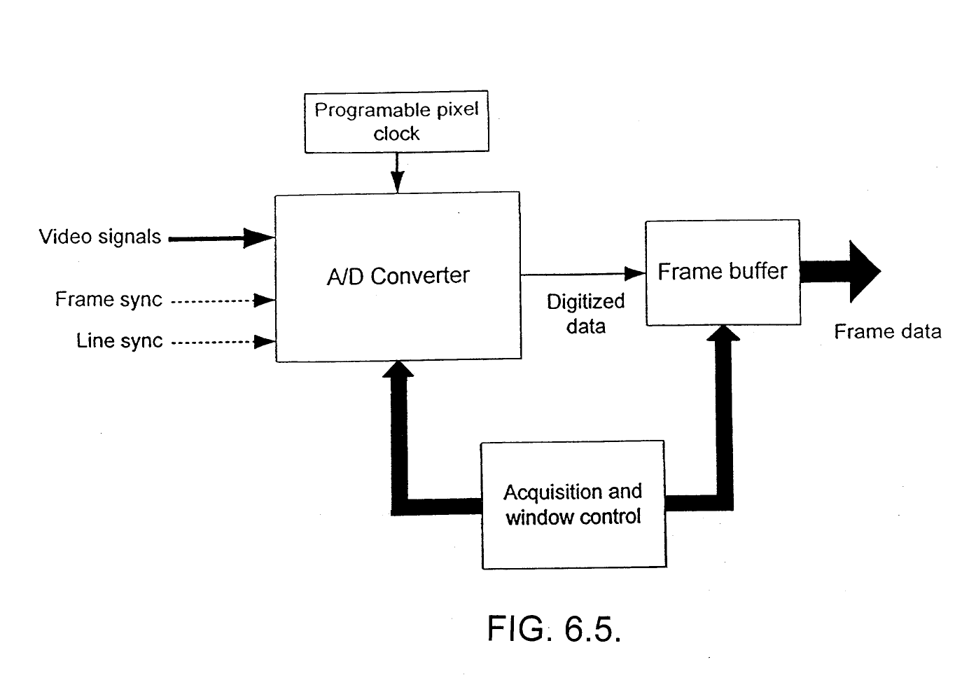

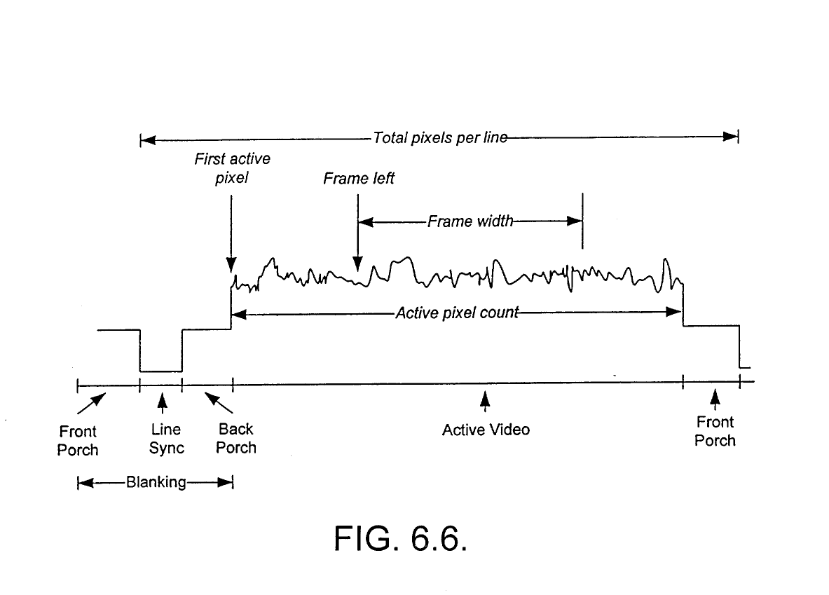

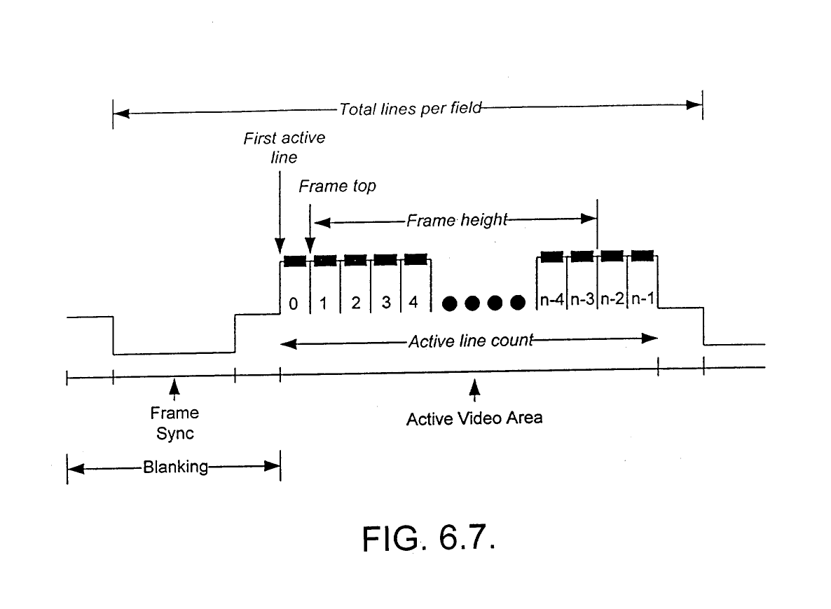

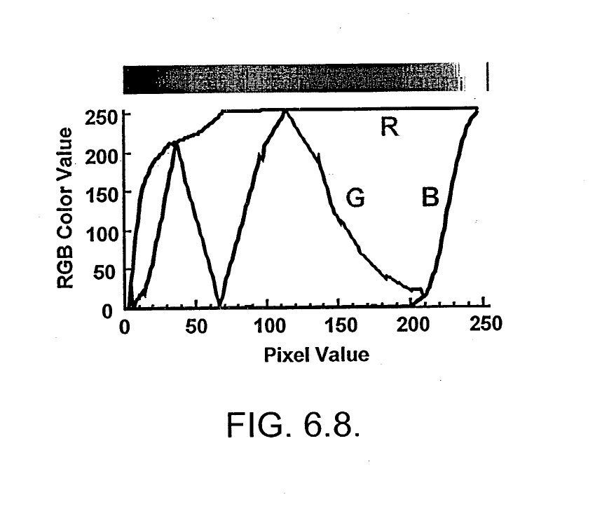

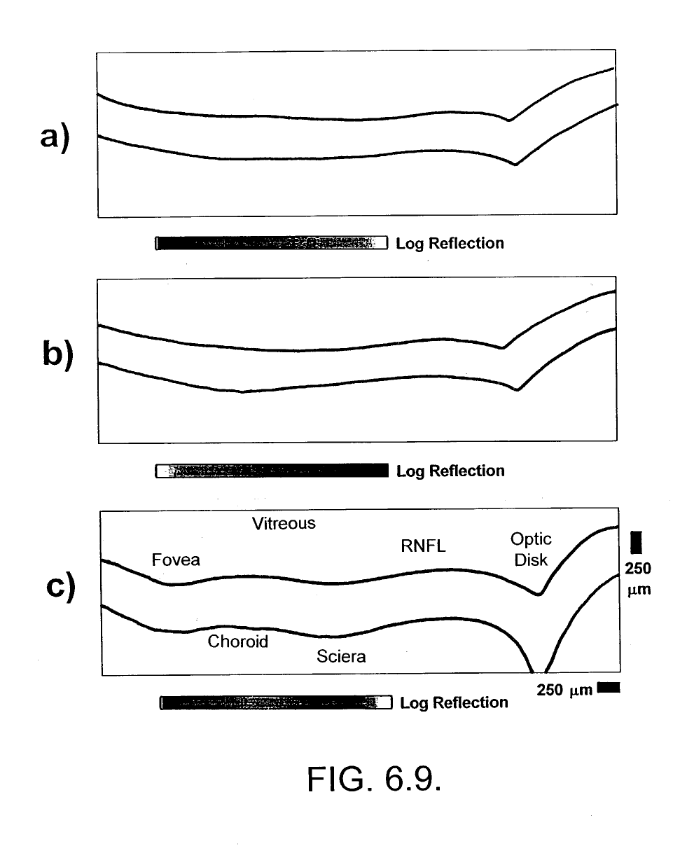

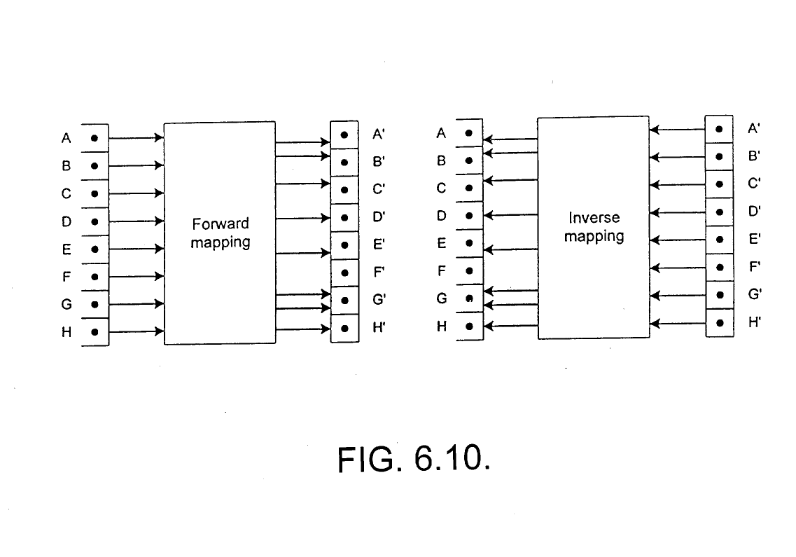

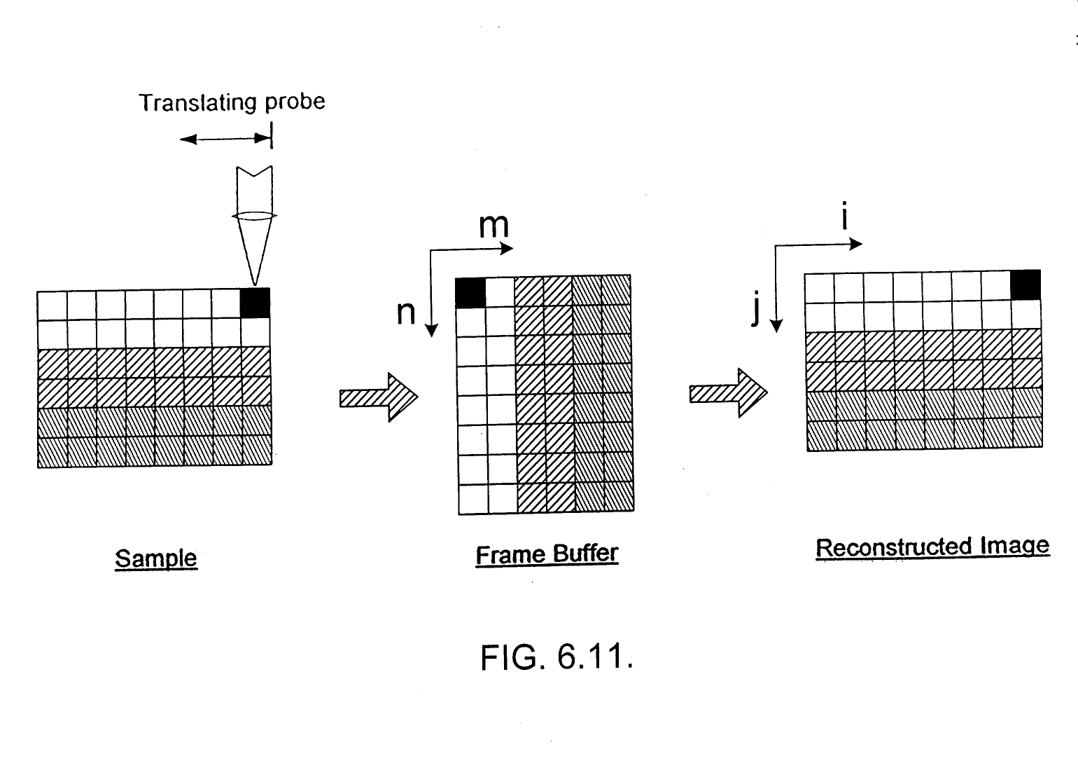

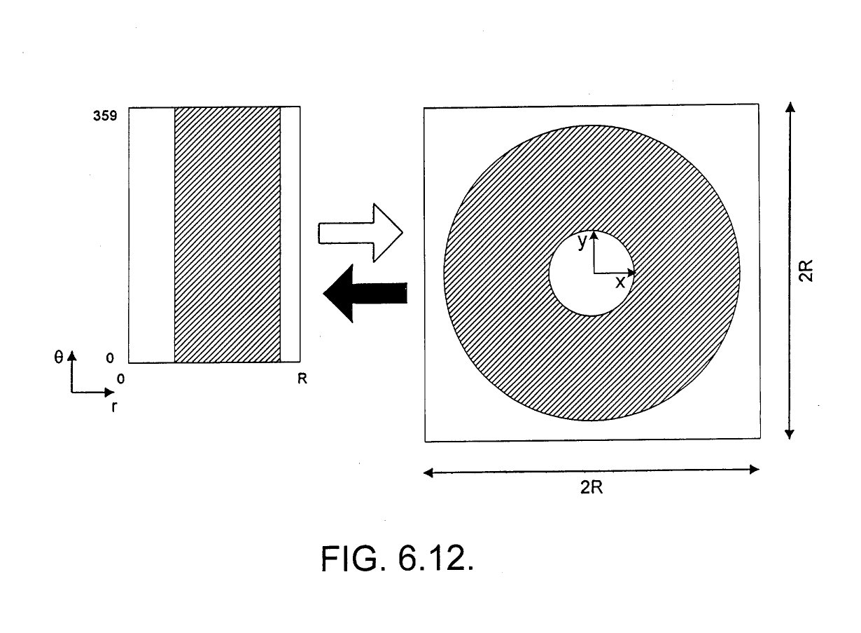

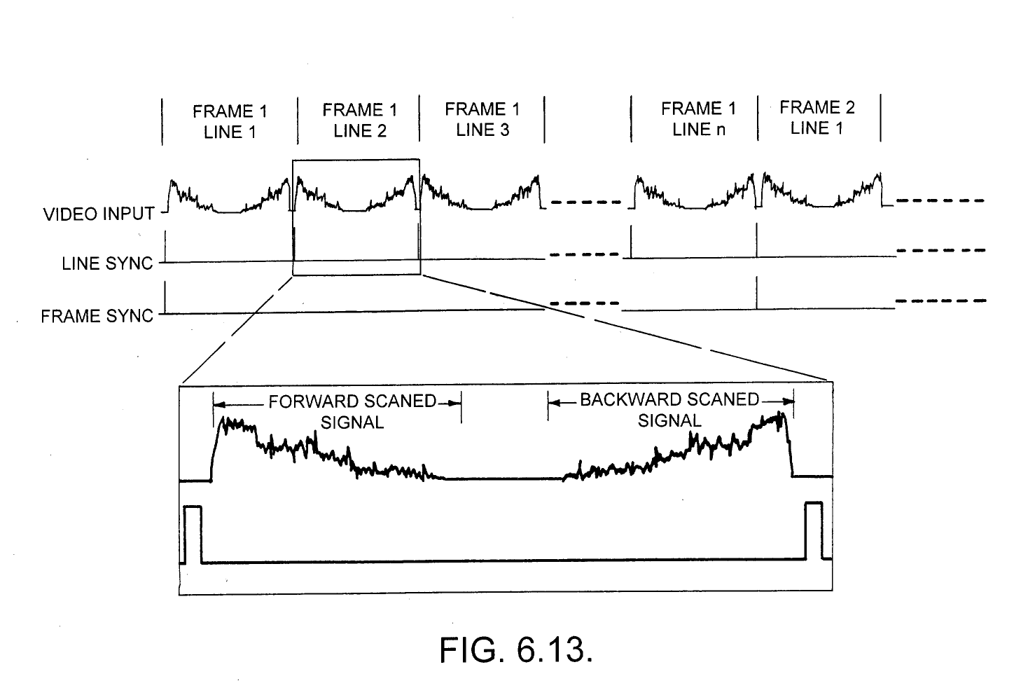

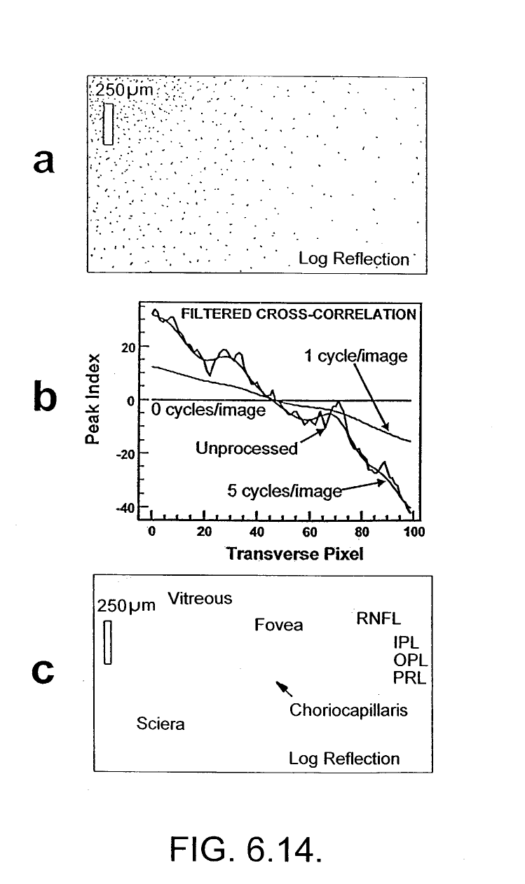

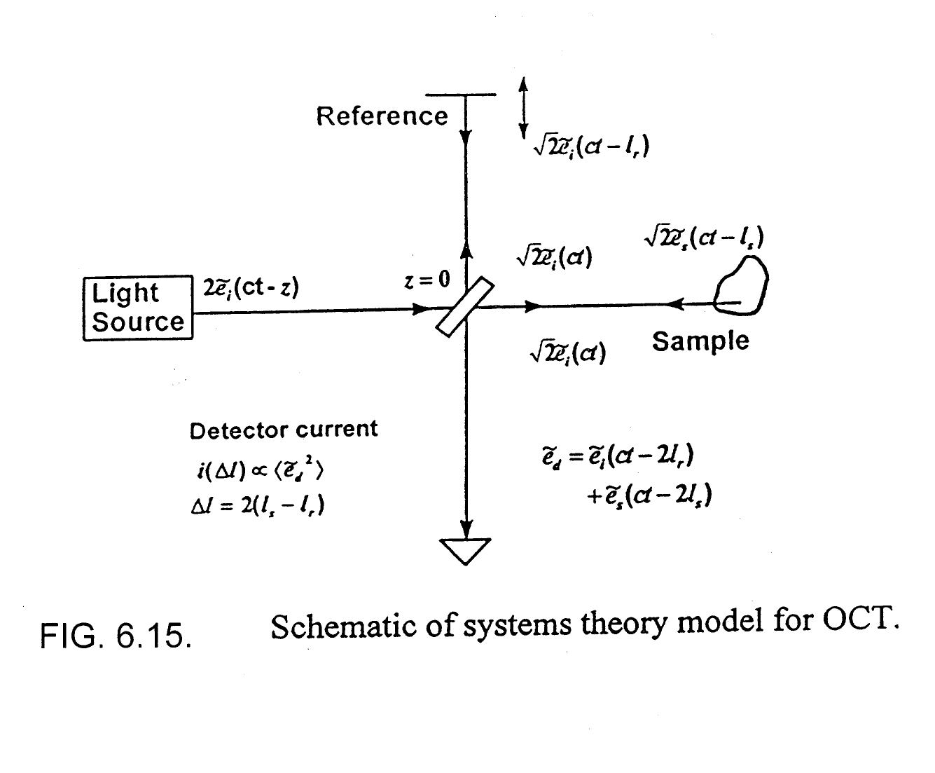

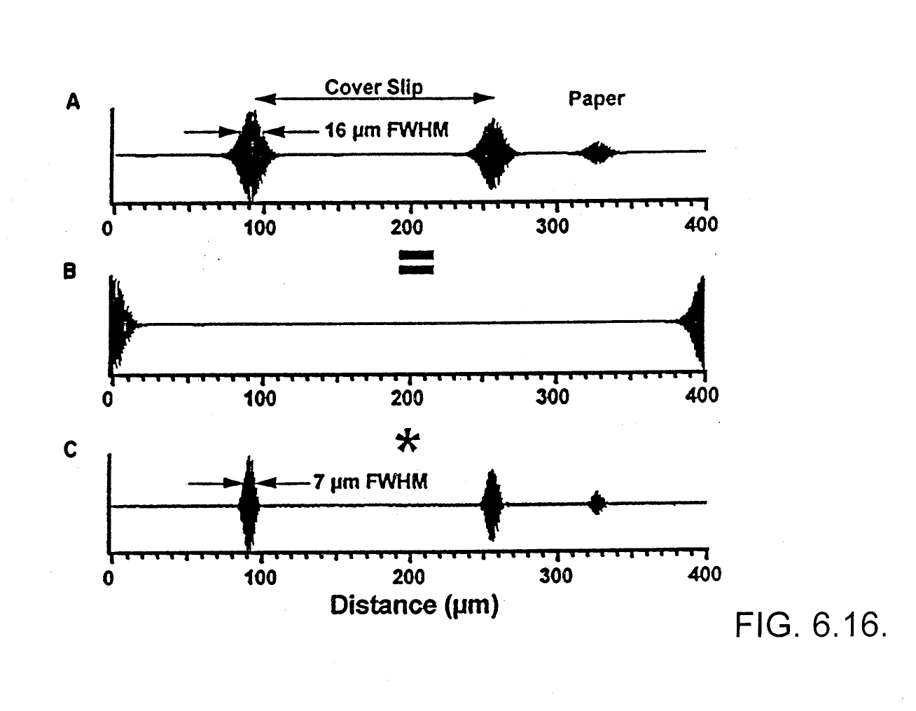

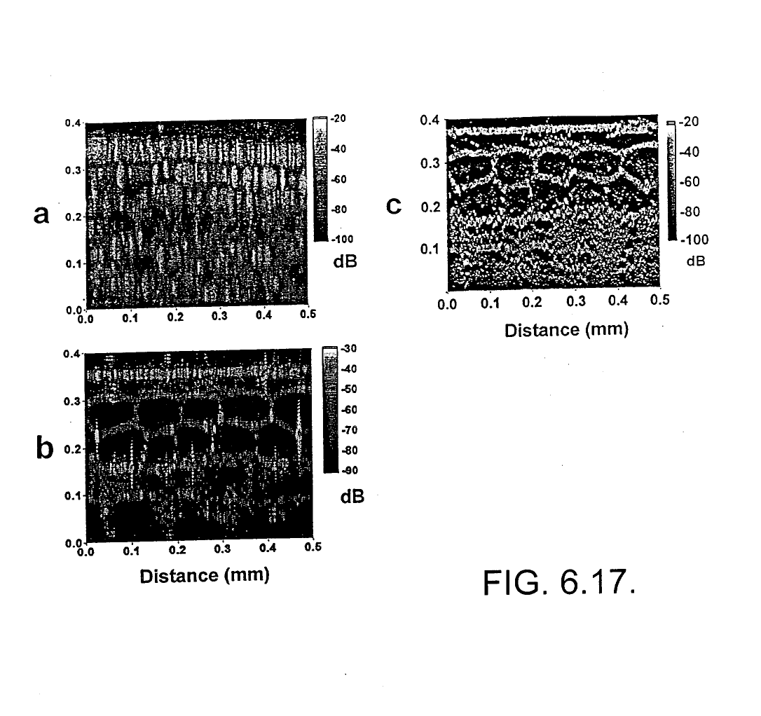

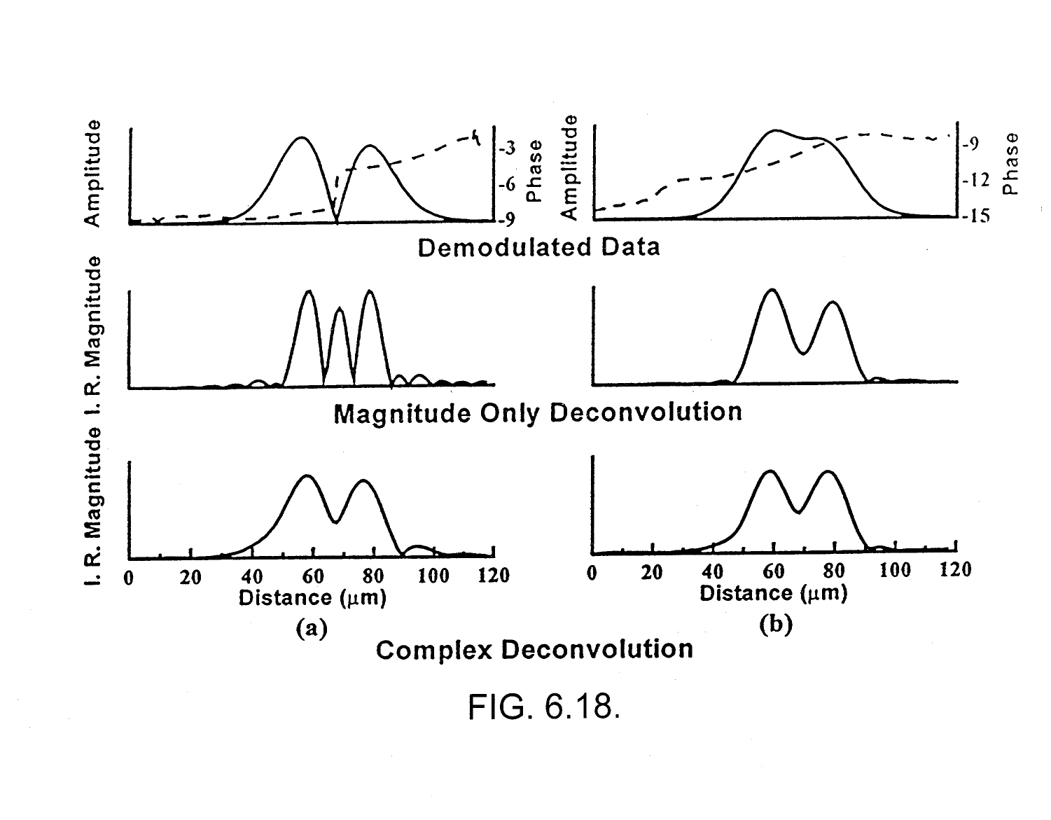

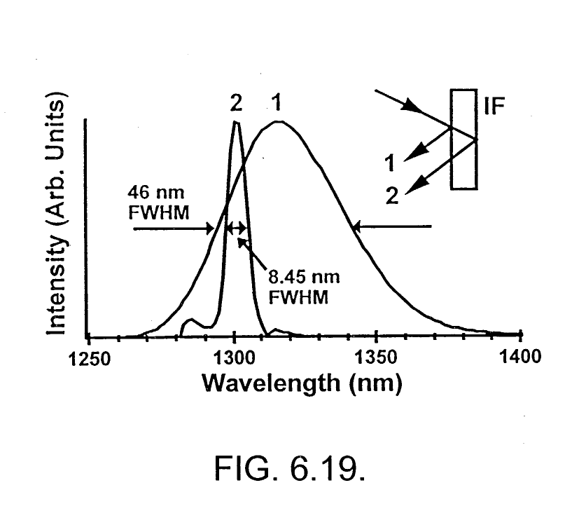

This section addresses the integration of the component technologies of OCT, as described in the preceeding sections, into a complete imaging system (see FIG. 6.1). This includes both hardware considerations including optimal interferometer topologies and scan synchronization dynamics, as well as software issues including image acquisition, transformation, display, and enhancement. A limited discussion of first-generation slow-scan systems (<1 image/sec) is included where it is illustrative; however, most of the discussion centers upon state-of-the-art OCT systems acquiring images in near real time.

6.1 Hardware Implementation

6.1.1 Interferometer Topologies for Optimal SNR

The original and most common interferometer topology used in OCT systems is a simple Michelson interferometer, as depicted in earlier chapters. In this design, low-coherence source light is split by a 50/50 beamsplitter into sample and reference paths. A retroreflecting variable optical delay line (ODL) comprises the reference arm, while the sample specimen together with coupling and/or steering optics comprise the sample arm. Light retroreflected by the reference ODL and by the sample is recombined at the beamsplitter and half is collected by a photodetector in the detection arm of the interferometer. Heterodyne detection of the interfering light is achieved by Doppler shifting the reference light with a constant-velocity scanning ODL, or by phase modulating either the sample or reference arm. Single-mode fiber implementation of the interferometer has the advantages of simplicity and automatic assurance of the mutual spatial coherence of the sample and reference light incident on the detector. Although this design is intuitive and simple to implement, it is apparent that due to the reciprocal nature of the beamsplitter, half of the light backscattered from the sample and from the reference ODL is returned towards the source. Light returned to the source is both lost to detection and may also compromise the mode stability of the source. Further, a detailed analysis of the signal-to-noise ratio in low-coherence interferometry [1, 2] mandates that in order to optimally approach the shot-noise detection limit for the Michelson topology, the reference arm light must be attenuated by several orders of magnitude (depending upon the source power level and the detector noise figure). Thus, in typical OCT implementations, up to 75% (or 6 dB) of the optical power supplied by the source does not contribute to image formation. Since light sources with high spatial coherence and low temporal coherence suitable for high-speed OCT imaging in very low backscattering samples such as biological tissue are very expensive, optical power is a commodity well worth conserving in OCT systems.

Using optical circulators, unbalanced fiber couplers, and balanced heterodyne detection, two authors have recently demonstrated a new family of power-efficient fiber-optic interferometer topologies which recover most or all of the light lost in the Michelson configuration [2, 3]. The three-port optical circulator is a non-reciprocal device which couples light incident on port I to port II, and light incident on port II to port III. Current commercial fiber-coupled devices specify insertion losses less than 0.7 dB (I to II, II to III) and isolation (III to II, II to I) and directivity (I to III) greater than 50 dB. Single mode wideband fiberoptic couplers are commercially available with arbitrary (unbalanced) splitting ratios. Balanced heterodyne reception is an established technology in coherent optical communications [4, 5], and has previously been used in OCDR [6] and in OCT [3, 7-9].

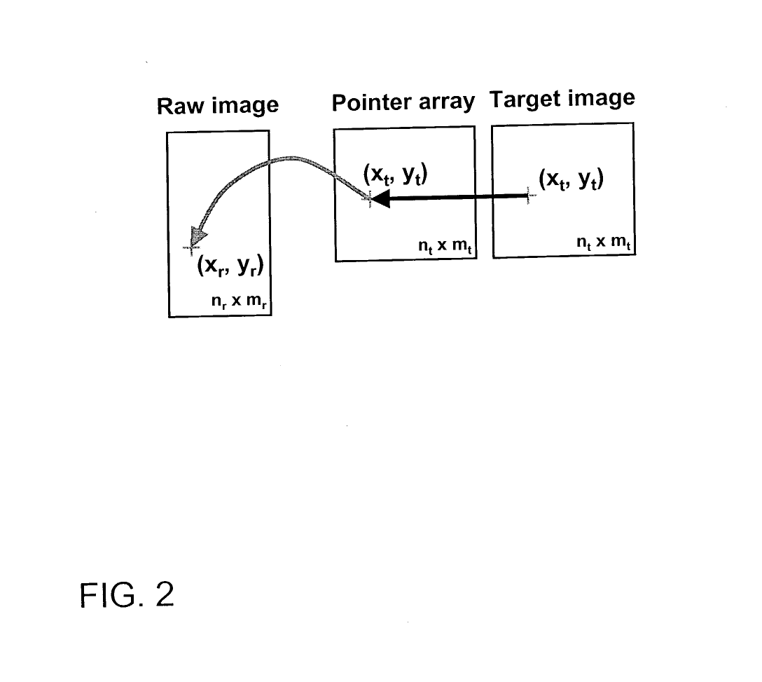

Three types of new interferometer designs described by Rollins et al [2] utilizing these enabling technologies are illustrated in FIG. 6.2. The first design (FIG. 2A) uses a Mach-Zehnder interferometer with the sample located in one arm and the reference ODL in the other arm. The first coupler is unbalanced with a splitting ratio chosen to optimize SNR by directing most of the source light to the sample. Light is coupled to the sample through an optical circulator so that the backscattered signal is collected by the delivery fiber and redirected to the second coupler. The reference ODL may be transmissive, or alternatively, a retroreflecting ODL may be used with a second circulator. Design Aii of FIG. 6.2 is similar to Ai except that instead of balanced heterodyne detection, a second unbalanced splitter is used to direct most of the sample light to a single detector. Although less expensive to implement, the performance of the single detector version is significantly worse than the balanced detector version since a single detector does not suppress excess photon noise.

Interferometer design B is similar to design A, as shown in the schematics labeled Bi and Bii in FIG. 6.2. In this case, a retroreflecting ODL is used without the need for a second optical circulator. Configuration Bii has recently been demonstrated for endoscopic OCT [3].

Design C uses a Michelson interferometer efficiently by introducing an optical circulator into the source arm instead of the sample arm, as in designs A and B. Configuration Ci utilizes a balanced receiver. Configuration Ci has the significant advantage that an existing fiber-optic Michelson interferometer OCT system can be easily retrofitted with a circulator in the source arm and a balanced receiver with no need to disturb the rest of the system. One drawback of configuration Ci is that more light is incident on the detectors than in the other configurations. Although the balanced receiver is effective in suppressing excess photon noise, a lower gain receiver is necessary to avoid saturation of the detectors. In a high speed OCT system, however, this is not an issue because a lower gain receiver is necessary to accommodate the broad signal bandwidth. Design Ci has also recently been demonstrated for use in endoscopic OCT [9]. Design Cii uses an unbalanced splitter and a single detector.

A published theoretical analysis of the signal-to-noise ratio for all of the designs illustrated in FIG. 6.2 [2] illustrates that with the proper choice of coupler splitting ratios and balanced receiver configurations, the three dual-balanced detection configurations may provide an increase in SNR of between 6 and 8 dB as compared to the standard Michelson topology. The expected increase in SNR beyond the 6 dB power loss of the Michelson is due to the additional capability of balanced reception to reduce excess photon noise [6]. The single-detector versions provide a more modest gain in SNR.

6.1.2 Analog Signal Processing

The critical function of the analog signal processing electronics in an OCT system is to extract the interferometric component of the voltage or current signal provided by the detection electronics with high dynamic range and to prepare it for analog-to-digital conversion. Other functions which could potentially be performed at this stage include signal processing operations for image enhancement, such as deconvolution, phase contrast, polarization-sensitive imaging, or Doppler OCT. Although to date almost all such image enhancement processing has been performed in software, as high-speed imaging systems become more prevalent, pre-digitization time-domain processing will inevitably become more sophisticated. For example, a recent demonstration of real-time signal processing for Doppler OCT have utilized an analog approach [10].

Demodulation of the interferometric component of the detected signal may be performed using either an incoherent (i.e. peak detector) or coherent (quadrature demodulation) approach. Many early low-speed OCT systems for which the Doppler shift frequency did not exceed several hundred kHz utilized a simple custom circuit employing a commercially available integrated-circuit RMS detector in conjunction with a one- or two-pole bandpass filter for incoherent demodulation [11, 12]. Even more simply, satisfactory coherent demodulation can be accomplished using a commercial dual-phase lock-in amplifier without any other external components [13, 14]. By supplying the lock-in amplifier with a reference sine wave at the calculated reference arm Doppler shift frequency and using the lock-in time constant as a good-quality high-order low-pass filter, the amplitude of the sum of the squares of the in-phase and quadrature outputs provides a high-dynamic range monitor of the interferometric signal power. In more recent high-speed OCT system implementations employing modulation frequencies in the MHz range, more sophisticated electronics based on components designed for the ultrasound and cellular radio communications markets have been employed [3, 9, 15-18].

6.1.2.1 Dynamic Range Compression

As discussed in previous chapters, typical OCT systems routinely achieve sensitivity (defined as the minimum detectable optical power reflectivity of the sample) well in excess of 100 dB. Since the electronic interferometric signal amplitude (current or voltage) is proportional to the product of the reference and sample arm electric fields and thus to the square root of the sample power reflectivity, the signal-to-noise ratio of the electronic signal amplitude usually exceeds 50 dB. This value both exceeds the dynamic range of the human visual system (which can sense brightness variations of only about 3 decades in a particular scene) and also approaches the dynamic range limit of many of the hardware components comprising the signal detection/processing/digitization chain. For example, the dynamic range of an A/D converter is given by 2^{2N}(≅6N dB), where N is the number of bits of conversion; thus an 8-bit converter has a dynamic range of only 48 dB. For early OCT systems employing slow pixel digitization rates of only a few hundred kilohertz, this latter issue was not a limiting factor since high dynamic range A/D converters (i.e. up to 16 bit) are common and inexpensive at these data rates. For high-speed OCT imaging, however, MHz digitization rates are required and the dynamic range of the digitization step becomes an increasingly important factor both in terms of digitizer cost as well as in downstream computation speed.

In order for an OCT image to be rapidly digitized and meaningfully observed, a means of hardware or software dynamic range compression is often employed. This is accomplished by transforming the detected sample reflectivity values with a nonlinear operation that has a maximum slope for low reflectivity values and a decreasing slope for increasing reflectivity values. The obvious and convenient method is to display the logarithm of reflectivity in units of decibels. The logarithm operation demonstrates the desired transform characteristic, and decibels are a meaningful, recognizable unit for reflectivity. The logarithm is not the only possible dynamic range compression transform. For example, the bylaw transform of communications systems, or a sinusoidal transform could be used, but up to the present time, logarithmic compression is universal in display of OCT images.

Since the first reports of OCT, images have conventionally been displayed in logarithmic format, usually having been transformed in software [19]. Although plots of A-scan data can be well visualized on a linear scale, in two-dimensional images displayed with a linear intensity scale only the brightest features are perceived (see, for example, [20]). It is notable that the common definition of axial resolution in OCT as being given by half the coherence length of the light source is valid only when the data is presented on a linear scale; the 3-dB point of a sharp reflection in a logarithmically transformed image depends upon the dynamic range of the image data and is thus not well defined, but is clearly wider than the half-coherence length.

Several options for hardware analog dynamic range compression are available. An approach which has been utilized in several OCT implementations compresses the dynamic range of the signal before sampling by using an amplifier with a nonlinear gain characteristic [9, 11]. In this way, commonly available data acquisition boards and frame grabbers with linear quantum levels can still be used for digitization. Demodulating logarithmic amplifiers are commercially available which compress the dynamic range of the OCT signal and also perform envelope detection. Alternatively, A/D converters are available with non-linearly spaced quantum levels, for example following the μ-law transform. This would allow the low-reflectivity range to be sampled with high A/D dynamic range, while sacrificing A/D dynamic range when sampling the high-reflectivity range, where it is not needed. Devices are also available which perform sinusoidal transformations.

6.1.3 Synchronization Electronics

As illustrated in FIG. 6.1, every OCT system implementation includes at least some form of optical delay line, sample scanning optics, and digitization/display electronics whose dynamic functions must be coordinated to acquire meaningful image data. In addition to the synchronization of these elements which is common to all OCT systems, specially designed systems may also require coordination of dynamic properties of the optical source (e.g., frequency-tunable source implementations [21]), detection electronics, or analog signal processing electronics (e.g., frequency-tracking demodulators [22]).

A diagram illustrating the timing relationships between the elements in a standard minimal system is illustrated in FIG. 6.3. For most common systems which employ depth-priority scanning (i.e., in which depth A-scans are acquired more rapidly than lateral scans), individual image pixels are acquired in the 1 kHz-10 MHz range, the reference optical delay has a repetition rate in the 10 Hz-10 kHz range, and the lateral sample scanning optics repeat at 0.1-10 Hz frequencies. The optical delay line is driven by a waveform which is optimally a triangle or sawtooth to maximize the duration of the linear portion of the scan and thus the usable scan duty cycle, although harmonic and other nonlinear delay waveforms have been used for the fastest delay lines yet reported [18, 23]. In either case, the synchronization electronics provide a frame sync signal synchronized to the sample lateral scan to signal to the image acquisition electronics to start image frame acquisition. Similarly, the synchronization electronics provide a line sync signal synchronized to the depth scan to signal the image acquisition electronics to start A-scan digitization. In most OCT system implementations described to date, a pixel clock is generated by a synthesized source (i.e. by a function generator or on-board A/D conversion timer) at a digitization rate given by the line scan rate multiplied by the number of desired pixels per line. However, an OCT system specially designed for coherent signal processing (utilized both for OCT image deconvolution [24] and for spectroscopic OCT [25]) has been reported which utilized a helium-neon based reference arm calibration interferometer to provide a pixel clock sync signal coordinated to the actual reference optical delay with nanometer accuracy. Lateral-priority scanning OCT systems have also been reported; in this case the timing of the depth and lateral scans are reversed [13, 26-28].

The hardware comprising the synchronization and image acquisition electronics may be as simple as a multifunction data acquisition board (analog-to-digital, digital-to-analog, plus timer) residing in a personal computer. Alternatively, as described in the next section, a standard video frame grabber board may be programmed to perform the same functions at much higher frame rates.

6.1.4 Example of an Integrated OCT System

As an example of an integrated OCT system, a block diagram of a rapid-scan system designed for endoscopic evaluation of early cancer is provided in FIG. 6.4 [9]. The high speed OCT interferometer is based on a published design [18]. It includes a high-power (22 mW), 1.3 μm center wavelength, broadband (67 nm FWHM) semiconductor amplifier-based light source, and a Fourier-domain rapid-scan optical delay line based on a resonant optical scanner operating at 2 kHz. Both forward and reverse scans of the optical delay line are used, resulting in an A-scan acquisition rate of 4 kHz. Image data is digitized during the center two-thirds of the forward and reverse scans, for an overall scanning duty cycle of 67%.

In this system, OCT probe light is delivered to the region of interest in the lumen of the GI tract via catheter probes which are passed through the accessory channel of a standard GI endoscope. A specialized shaft, which is axially flexible and torsionally rigid, mechanically supports the optical elements of the probe. The probe beam is scanned in a radial direction nearly perpendicular to the probe axis at 6.7 revolutions per second (the standard frame rate in commercial endoscopic ultrasound systems) or 4 revolutions per second. The converging beam exiting the probe is focused to a minimum spot of approximately 25 μm.

Optical signals returning from the sample and reference arms of the interferometer are delivered via the non-reciprocal interferometer topology (FIG. 6.2Ci) to a dual-balanced InGaAs differential photoreceiver. The photoreceiver voltage is demodulated and dynamic range compressed using a demodulating logarithmic amplifier. The resulting signal is digitized using a conventional variable scan frame grabber residing in a Pentium II PC. The line sync signal for the frame grabber is provided by the resonant scanner controller, the frame sync signal is derived from the catheter probe rotary drive controller (1 sync signal per rotation), and the pixel clock is generated internally in the frame grabber.

The PC-based EOCT imaging system is wholly contained in a single, mobile rack appropriate for use in the endoscopic procedure suite. The system is electrically isolated and the optical source is under interlock control of the probe control unit. The system meets institutional and federal electrical safety and laser safety regulations. The data capture and display subsystem acquires image data at a rate of 4000 lines per second using the variable scan frame grabber. Alternate scan reversal is performed in software in order to utilize both forward and reverse scans of the optical delay line, followed by rectangular-to-polar scan conversion using nearest-neighbor interpolation (see below). Six hundred (or 1000) A-scans are used to form each image. A software algorithm performs these spatial transformations in real time to create a full-screen (600×600 pixels) radial OCT image updated at 6.7 (or 4) frames per second. Endoscopic OCT images are displayed on the computer monitor as well as archived to S-VHS video tape. Foot pedals controlling freeze-frame and frame capture commands are provided, allowing the endoscopist to quickly and effectively acquire data using the system.

6.2 Image Acquisition and Display

6.2.1 High Speed Data Capture and Display

6.2.1.1 Frame Grabber Technology

Frame grabbers are designed to digitize video signals, such as from CCD cameras, CID cameras, and vidicon cameras. If each frame of video signals is 640×480 pixels, the amount of memory needed to store it is about one quarter of a megabyte for a monochrome image having 8 bits/pixel. Color images requires even more memory, approximately three times this amount. Without a frame grabber, most inexpensive general-purpose personal computers cannot handle the bandwidth necessary to transfer, process, and display this much information, especially at the video rate of 30 frames per second. As a result, a frame grabber is always needed in an imaging system when displaying images at or approaching video rate.

A block diagram of a simple frame grabber is shown in FIG. 6.5. Typical frame grabbers are functionally comprised of four sections: an A/D converter, programmable pixel clock, acquisition/window control unit, and frame buffer. Video input is digitized by the A/D converter with characteristics, such as filtering, reference and offset voltages, gain, sampling rate and the source of sync signals controlled programmatically by the programmable pixel clock and acquisition/window control circuits. The frequency of the programmable pixel clock determines the video input signal digitization rate or sampling rate. In addition, the acquisition/window control circuitry also controls the region of interest (ROI) whose values are determined by the user. Image data outside of the ROI is not transferred to the frame buffer, and not displayed on the screen.

In order to utilize a frame grabber for general-purpose high-speed data acquisition, it is important to understand the nature of video signals and how their acquisition is controlled by frame grabber driver software. A video signal comprises a sequence of different images, each of which is referred to as a frame. Each frame can be constructed from either one (non-interlaced) or two (interlaced) fields, depending upon the source of the signal. Most CCD cameras generate interlaced frames. The even field in an interlaced frame would contain lines 0, 2, 4, . . . ; the odd field would contain lines 1, 3, 5, and so on.

FIG. 6.6 illustrates the components of a single horizontal line of non-interlaced video as well as the visual relationship between the signal components and the setting of the corresponding input controls. Upon the same basis, FIG. 6.7 shows the components of a single vertical field of video as well as the relationship between the signal and the setting of the corresponding input controls.

6.2.1.2 False Color/Gray Scale Mapping

Once digitized by a conventional A/D converter or frame grabber, two-dimensional OCT image data representing cross-sectional or en face sample sections is typically represented as an intensity plot using gray-scale or false-color mapping. The intensity plot typically encodes the logarithm of the detected signal amplitude as a gray scale value or color which is plotted as a function of the two spatial dimensions. The choice of the color mapping used to represent OCT images has a significant effect on the perceived impact of the images and on the ease (and expense) with which images can be reproduced and displayed.

Many authors [13, 14, 18, 21, 29-31] have used the standard linear gray scale for OCT image representation, with low signal amplitudes mapping to black and strong reflections appearing as white. Some groups [3, 32, 33] have opted for a reverse gray scale with strong reflections appearing as black on a white background, primarily motivated by the relative ease of printing and reproducing such images as compared to the standard gray scale. A large variety of false color maps have been applied to OCT images; the most widely used being the original blue-green-yellow-red-white “retina” color scale designed by David Huang while a graduate student at MIT for inclusion in the original paper describing OCT in 1991 [19]. This color map was adopted by Humphrey Systems, Inc. as the exclusive map for their OCT retinal scanner, and has also been used in some presentations of non-ophthalmic data [19]. A plot of the retinal false-color scale in RGB color space is reproduced in FIG. 6.8, and a comparison of an in vivo human retinal OCT image in each of the three color scales is provided in FIG. 6.9.

Recent innovations in OCT technology which enhance structural or morphological imaging by the addition of functional information (e.g. Doppler flow imaging [34, 35], polarization-sensitive OCT [36], spectroscopic OCT [25, 37]) face a difficult problem of representing all of the resulting information in a single image. To date, two different pseudo-color image coding schemes have been employed to combine depth-resolved blood flow imaging or spectroscopy with conventional OCT reflectivity imaging. These are based on two standard color models described in image processing texts [38]. Briefly, these are the RGB (red, green, blue) and HSL (hue, saturation, luminance) models. Hue is associated with the perceived dominant wavelength of the color, saturation is its spectral purity, or the extent to which the color deviates from white, and luminance is the intensity of color. In the RGB model, the relative contributions from red, green, and blue are used to describe these properties for an arbitrary color. In the HSL model, color intensity is controlled independently from the hue and saturation of the color.

Doppler OCT imaging [34, 35] has adapted an RGB color map to simultaneously indicate reflectivity and Doppler shifts. Blood flow data are thresholded to remove noise and superimposed on the reflectivity image. The standard linear gray scale is used to represent amplitude backscatter, whereas blood flow direction is indicated with hue (red or blue for positive or negative Doppler shifts, respectively). Higher luminance indicates increased flow magnitude.

Recently, a variation of the HSL colormap was introduced [37] for combining backscatter intensity and depth-resolved spectral shifts in tissue. As with the previous scheme, hue denotes a shift in the backscatter spectrum, where red, green, and yellow designate positive, negative, and no spectral shift, respectively. Saturation of each hue indicates tissue reflectivity, and the image contains constant luminance.

6.2.2 Image Transformations

In general, images may be defined in terms of two elementary sets: a value set and a point set [39]. The value set is the set of values which the image data can assume. It can be a set of integers, real, or complex numbers. The point set is a topological space, a sub-set of n-dimensional Euclidean space which describes the spatial location to which each of the values in the point set are assigned.

Given a point set X and a value set F, an image I can be represented in the form

I={(x,a(x)):xεX,a(x)εF}. (6.1)

An element of the image, (x,a(x)), is called a pixel, x is called the pixel location, and a(x) is the pixel value at the location x.

Two types of image transformations are of interest in processing of OCT images. Spatial transformations operate on the image point set and can accomplish such operations as zooming, de-warping, and rectangular-to-polar conversion of images. Value transformations operate on the value set and thus modify pixel values rather than pixel locations. Examples of useful value transformations include modifying image brightness or contrast, exponential attenuation correction, or image de-speckling.

6.2.2.1 Spatial Transformations

A spatial transformation defines a geometric relationship between each point in an input point set before transformation and the corresponding point in the output point set. A forward mapping function is used to map the input onto the output. A backward mapping function is used to map the output back onto the input (see FIG. 6.10). Assuming that [u, v] and [x, y] refer to the coordinates of the input and output pixels, the relationship between them may be represented as

[x, y]=[X(u, v),Y(u, v)]or [u, v]=[U(x, y),V(x, y)], (6.2)

where X and Y are the forward mapping functions and U and V are the backward mapping functions.

6.2.2.1.1 Spatial Transformation Matrices

In a rectangular coordinate system, linear spatial transformations (e.g. translation, rotation, scaling, and shearing etc.) can be expressed in matrix form using a transformation matrix T₁[39]

$$[ \begin{matrix}x \\ y \\ 1\end{matrix} ] = {T}_{1} [ \begin{matrix}u \\ v \\ 1\end{matrix} ] , where {T}_{1} = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] . \qquad ( 6.3 )$$

The 3×3 transformation matrix T₁ can be best understood by partitioning it into 4 separate submatrices. The 2×2 submatrix

$$[ \begin{matrix}{a}_{11} & {a}_{12} \\ {a}_{21} & {a}_{22}\end{matrix} ]$$

specifies a linear transformation for scaling, shearing, and rotation. The 2×1 submatrix [a₁₃ a₂₃]^{T} produces translation. The 1×2 submatrix [a₃₁ a₃₂] produces perspective transformation. The final 1×1 submatrix [a₃₃] is responsible for overall scaling and usually takes a unity value. Note that the superscript T denotes matrix transposition, whereby rows and columns are interchanged. Examples of simple useful transformation matrices in rectangular and polar coordinates are provided in Table 6.1.

6.2.2.1.2 Mapping Arrays

Non-linear spatial transformations which cannot be performed using transformation matrices (e.g. coordinate system conversions) can be performed using a mapping array. Specification of a mapping array is also a useful and necessary step in the computer implementation of linear spatial image transforms. A mapping array has the same dimensions as an expected output image. This array represents the point set of an output image in which each element contains the location of an input pixel. With the mapping array, the value set of the output image can be obtained by backward mapping to the input image. In a software implementation of image transformations, the required mapping array needs to be created only once and stored in memory. This approach minimizes computation time while imaging as compared to iterative formula-based calculation of image transformations in real time.

6.2.2.1.3 Image Rotation

Image rotation is a commonly used image transformation in high-speed OCT systems in which depth-priority OCT images (those acquired using a rapid z-scan and slower lateral scan) are captured using a frame grabber (which expects video images having a rapid lateral scan). The image rotation transformation is illustrated in FIG. 6.11. A 90-degree-rotation mapping array is created to reconstruct an image of the sample from the frame buffer of the frame grabber.

In this case, the spatial transformation used for creating a mapping array is

$$[ \begin{matrix}m \\ n \\ 1\end{matrix} ] = [ \begin{matrix}0 & 1 & 0 \\ - 1 & 0 & J \\ 0 & 0 & 1\end{matrix} ] [ \begin{matrix}i \\ j \\ 1\end{matrix} ] , \qquad ( 6.4 )$$

where

i=(0, 1, . . . , I), j=(0, 1, . . . ,J),

m=(0, 1, . . . ,M), n=(0, 1, . . . , N), I=N, and J=N.

6.2.2.1.4 Rectangular-to-Polar Conversion

Rectangular to polar conversion is necessary when image data is obtained using a radially scanning OCT probe, such as an endoscopic catheter probe [9, 40]. The A-scans will be recorded, by a frame grabber for example, sequentially into a rectangular array, but must be displayed in a radial format corresponding to the geometry of the scanning probe, as illustrated in FIG. 6.12. The forward mapping operations are:

x(r,θ)=r cos(θ)

y(r,θ)=r sin(θ)′ (6.5)

where x and y are the rectangular (Cartesian) coordinates and r and θ are the polar coordinates. The inverse mapping operations are:

r(x,y)=\sqrt{x²+y²}

$$θ ( x , y ) = {tan}^{- 1} ( \frac{y}{x} ) . \qquad ( 6.6 )$$

In the calculation of θ, an additional conditional is necessary because of ambiguity between the first and third, and second and fourth quadrants of the polar coordinate system.

6.2.2.1.5 Double-Sided Scan Correction

When an OCT system utilizes double-sided scanning (i.e., A-scan acquisition during both directions of the reference arm scan), a transformation is necessary to rectify the alternate, reversed A-scans (FIG. 6.13). Again, a mapping array can be constructed to transform the acquired image array into the image array to be displayed. When implementing double-sided scanning correction, it is necessary that consecutive A-scans are registered with respect to one another. Depending upon the OCT system configuration, the scan registration may be accomplished by adjusting the delay line optics. In a clinical setting, however, where the hardware is closed, it may be more desirable to implement a software registration mechanism. This could be accomplished by allowing manual adjustment by the operator, or by an automatic registration algorithm.

6.2.2.1.6 Image De-Warping

An acquired OCT image will be warped if the spatial distribution of the acquired data does not directly correspond to the spatial distribution of scattering profile of the sample. This occurs in OCT imaging when the image data is not sampled at regular intervals in space. For example, if the scanning motion of the OCT probe or delay line is not linear with time, and the data is sampled at regular intervals in time, then the image will be warped. If the scan nonlinearity is a known function of time, however, the image can be ‘de-warped’ by an appropriate spatial transformation. This is the case, for example, for the sinusoidal motion of a resonant scanning device. In this case, the coordinate corresponding to the resonant scanner can be transformed by a sinusoidal function with a period corresponding to the period of the scan in image space. Alternatively, if an accurate reference signal is available, a corresponding sampling trigger signal could be generated to sample nonlinearly in time such that the image is sampled linearly in space. This latter technique is common in Fourier transform spectrometers, and has previously been applied in high-accuracy interferogram acquisition in OCT [24].

6.2.2.1.7 Motion Artifact Reduction by A-can Registration

In OCT imaging of living human or animal subjects, motion artifact is a serious concern because the inherent spatial resolution of OCT imaging often exceeds the extent to which the subject is capable of remaining motionless under voluntary control. The most straightforward approach to eliminate this problem is to acquire images more rapidly, and the recent advent of high-speed scanning systems has in large part alleviated this concern [18, 33]. However, in cases where the available signal-to-noise ratio precludes high-speed imaging (as, for example, in retinal imaging where high-power sources cannot be used), image processing techniques can be applied.

The technique of cross-correlation scan registration for retinal image motion artifact reduction was developed by Hee and Izatt in 1993 [12, 41]. In this technique, an estimate of the patient's axial eye motion during image acquisition was formed from the peak of the cross-correlation Rᵢ(k) of each A-scan in the image with respect to its neighbor:

$${R}_{i} ( k ) = {\sum }_{i} {F}_{i} ( j ) {F}_{i + 1} ( j - k ) . \qquad ( 6.7 )$$

Here, Fᵢ(j) is the longitunidal scan data at the transverse scan index i, where j is the longitunidal pixel index. The profile of the motion estimated from the locus of the peaks of Rᵢ(k) was then low-pass filtered in order to separate motion artifacts (which were assumed to occur at relatively high spatial frequency) from real variations in the patient's retinal profile (which were assumed to occur at relatively low spatial frequency). The smoothed profile was then subtracted from the original profile to generate an array of offset values which were applied to correct the positions of each A-scan in the image. An illustration of this procedure and its results is provided in FIG. 6.14.

It is worth noting that the position of the peak of the cross-correlation function in retinal images appears to depend heavily upon the position of the retinal pigment epithelium (RPE). In images in which the strong RPE reflection is absent in some A-scans (for example, underneath strongly attenuating blood vessels), the cross-correlation technique is subject to registration errors. In such cases, a motion profile may alternatively be obtained by thresholding the A-scan data to locate the position of a strong reflectivity transition within the tissue structure, such as occurs at the inner limiting membrane. Thresholding at this boundary has recently been applied for A-scan registration of Doppler OCT images in the human retina [42]. In this case, the velocity data was also corrected by estimating the velocity of the patient motion from the spatial derivative of the scan-to-scan motion estimate and from knowledge of the A-scan acquisition time.

6.2.2.1 Value Set Operations

In contrast to spatial transformations, value set operations modify pixel values rather than pixel locations. Spatial filtering using convolution kernels are fundamental to image processing and can of course be applied to OCT images. Examples of useful convolution kernels include smoothing filters and edge detectors. OCT technology is relatively young, however, and extensive use has not yet been made of standard image processing techniques.

6.2.2.1.2 Exponential Correction

A value set operation which is not linear and can not be implemented using a convolution kernel is exponential correction. In the single-scattering approximation, the detected OCT photodetector power from a scattering medium attenuates with depth according to ([28]; see also Chapter on Optical Coherence Microscopy):

<iₛ>²∝F(z)·Exp[−2μₜz]. (6.8)

Here F(z) is a function of the focusing optics in the sample arm, μₜ is the total attenuation coefficient of the sample (given by the sum of the absorption and scattering coefficients), and z is the depth into the sample. If the depth of focus of the sample arm optics is larger than several attenuation mean-free-paths (given by 1/μₜ) in the sample, then the function F(z) is relatively smooth over the available imaging depth and the attenuation may be considered to be dominated by the exponential term. If this condition is not met (i.e. for imaging with high numerical aperture), then the complete form of equation 6.8 must be taken into account. Equation 6.8 has been experimentally verified in model scattering media [28]. Thus, the reflectivity profile measured by OCT in a typical imaging situation is scaled by an exponential decay with depth. Because this decay is intuitively understood and expected, it is typically not corrected. It is possible, however, to correct the data such that a direct map of sample reflectivity is displayed. The analogous decay in ultrasound imaging is commonly corrected by varying the amplifier gain as a function of time by an amount corresponding to the decay (“time-gain compensation,” or “TGC”). In principle, this approach could also be used in OCT by varying the gain with an exponential rise corresponding to the inverse of the expected exponential decay: e^{2μt/v}, where v is the speed of the depth scan. This approach can also be implemented after sampling by simply multiplying each A-scan point by point with an exponential rise, e^{2μz}. This correction assumes, however, that the sample surface exactly corresponds to the first pixel of the A-scan. When not true, this assumption will produce error, especially when the location of the tissue surface varies from one A-scan to another. This error can be mitigated by first locating the sample surface, then applying the correction from that location on: e^{2μ(z-z(0))}, where z(0) is the location of the sample surface. Alternatively, it can be noted that the error amounts to a scaling error and the index of the surface location can be used to correct the scale. It should be noted that if the data has been logarithmically compressed, then the correction is simply a linear rise. It is clear that information is not added to the image by application of this type of correction, noise is scaled together with signal, and the deeper sample regions become extremely noisy. Therefore, it is a subjective matter whether exponential correction improves or worsens the image viewability.

6.3 Signal Processing Approaches for Image Enhancement

6.3.1 Systems Theory Model for OCT

In order to make use of signal and image processing concepts which are well known and have been extensively used in other medical imaging modalities, it is useful to describe OCT from a systems theory point of view. Fortunately, several authors have noted that since the low-coherence interferometer at the heart of OCT is basically an optical cross-correlator, it is straightforward to construct a simple transfer function model for OCT which treats the interaction of the low-coherence interferometer with the specimen as a linear time-invariant system [24, 43-45].

As the basis for the following sections on coherent signal processing in OCT, the model developed by Kulkarni [24, 45] is here summarized. In this model, an optical wave with an electric field expressed using complex analytic signal representation as 2\tilde{e}ᵢ=2eᵢ(ct−z)exp[j2πk₀(ct−z)] is assumed to be incident on a Michelson interferometer, as illustrated in FIG. 6.15. We adopt a notation wherein variables overbarred by a tilde symbol (~) represent modulated quantities, whereas identical variables not so marked represent their complex envelopes. Thus, eᵢ(ct−z) is the complex envelope of the electric field, k₀ is the central wave number of the source spectrum, and c is the free space speed of light. The quantities t and z represent the time and distance traveled by the wave, respectively. It is assumed for the purpose of this model that the dispersion mismatch between the interferometer arms is negligible. By setting z=0 at the beamsplitter, the field returning to the beam splitter from the reference mirror is given by

\sqrt{2}\tilde{e}ᵢ(t,2lᵣ)=\sqrt{2}eᵢ(ct−2lᵣ)exp[j2πk₀(ct−2lᵣ)], (6.9)

where lᵣ is the the reference arm optical path length. In the sample arm, the light backscattered from the sample with optical path length lₛ reaching the beam splitter is given by

\sqrt{2}\tilde{e}ₛ(t,2lₛ)=\sqrt{2}eₛ(ct−2lₛ)exp[j2πk₀(ct−2lₛ)]. (6.10)

Here eᵢ(ct−2lₛ) is the complex envelope of the backscattered wave. The fields returning from the reference and sample arms interfere at the detector to provide the superposition field \tilde{e}_{d}=\tilde{e}ᵢ+\tilde{e}ₛ. The alternating component of the detector current is given by

ĩ(Δl)∝<\tilde{e}ᵢ(ct−2lₛ)\tilde{e}ₛ*(ct−2lₛ)>+<\tilde{e}ᵢ*(ct−2lᵣ)\tilde{e}ₛ(ct−2lₛ)>, (6.11)

where the angular brackets indicate temporal integration over the response time of the detector and Δl=2(lᵣ−lₛ) is the round-trip path length difference between the interferometer arms.

The source autocorrelation can be measured by monitoring the interferometric signal when a perfect mirror is used as a specimen in the sample arm. We define the source interferometric autocorrelation function as:

\tilde{R}ᵢᵢ(Δl)≡<\tilde{e}ᵢ(ct−2lᵣ)\tilde{e}ᵢ*(ct−2lₛ)>=Rᵢᵢ(Δl)exp(j2πk₀Δl), (6.12)

where Rᵢᵢ(Δl) is the autocorrelation of the complex envelopes of the electric fields. The autocorrelation function Rᵢᵢ(Δl) is experimentally measured by demodulating the detected interferogram at the reference arm Doppler shift frequency, and recording the in-phase and quadrature components of this complex signal. According to the Wiener-Khinchin theorem [46], the source spectrum is given by the Fourier transform of the interferometric autocorrelation function:

$${\tilde{S}}_{ii} ( k ) = {\int }_{- ∞}^{∞} {\tilde{R}}_{ii} ( Δ l ) exp [ - j 2 π k Δ l ] ⅆ ( Δ l ) . \qquad ( 6.13 )$$

For an arbitrary specimen in the sample arm, the interferometric cross-correlation function is defined as

\tilde{R}ᵢₛ(Δl)≡<\tilde{e}ᵢ(ct−2lᵣ)\tilde{e}ₛ*(ct−2lₛ))=Rᵢₛ(Δl)exp(j2πk₀Δl)., (6.14)

where Rᵢₛ(Δl) is the cross-correlation of the complex envelopes of the electric fields [46]. The cross-power spectrum \tilde{S}ᵢₛ(k) also follows by analogy:

$${\tilde{S}}_{is} ( k ) = {\int }_{- ∞}^{∞} {\tilde{R}}_{is} ( Δ l ) exp [ j2 π k ( Δ l ) ] ⅆ ( Δ l ) . \qquad ( 6.15 )$$

6.3.1.1 Sample Impulse Response

It is useful to represent the interaction between the specimen under study and the incident sample arm light as a linear shift-invariant (LSI) system, characterized by a frequency dependent transfer function [46-48]. The key insight this provides is that the transfer function H(k) and its inverse Fourier transform, the sample impulse response h(z), are physically meaningful quantities describing the backscatter spectrum and electric field reflection coefficient profile of the sample, respectively. We denote the impulse response experienced by the electric field \tilde{e}ᵢ by \tilde{h}(z) and that experienced by the complex envelope field eᵢ by h(z). This LSI model is valid when the contribution to eₛ from multiply scattered light is not significant.

The impulse response h(z) describes the actual locations and reflection coefficients of scattering sites within the sample, and convolves with the source electric field envelope to create the scattered electric field envelope:

eₛ(−z)=eᵢ(−z) [symbol] h*(z). (6.16)

Here [symbol] represents the convolution operation, and the negative sign implies scattering in the negative direction (back-scattering). Taking the Fourier transform of both sides of equation (6.16) provides

Eₛ(k)=Eᵢ(k)H*(k) (6.17)

where Eₛ(k), Eᵢ(k), and H(k) are the Fourier transforms of eₛ(z), eᵢ(z) and h(z), respectively. The assumption of shift invariance ensures that

eₛ(ct−2lₛ)=eᵢ(ct−2lₛ) [symbol] h*(−(ct−2lₛ)). (6.18)

Substituting equation (6.18) in the definition of the correlation functions (equations 6.12,6.14) provides

Rᵢₛ(Δl)=Rᵢᵢ(Δl) [symbol] h(Δl). (6.19)

The source autocorrelation function, Rᵢᵢ(Δl) and the cross-correlation function of the sample and reference arm electric fields, Rᵢₛ(Δl) thus constitute the input and measured output, respectively, of an LSI system having the impulse response h(z). Therefore, the impulse response which describes the electric field-specimen interaction as a function of z is exactly the same as that which connects the auto-and cross-correlation functions of the interferometer as a function of the path-length difference Δl. Thus, this model provides access to understanding the fundamental properties of the interaction of the sample with the sample arm electric fields by using simple correlation function measurements.

Equation 6.19 also leads directly to a simple, albeit naive approach for OCT image resolution improvement by deconvolution. Taking the Fourier transform of equation 6.19 and solving for the impulse response gives:

$$h ( Δ l ) ≡ h ( z ) = {F}^{- 1} \{ \frac{{S}_{is} ( k )}{{S}_{ii} ( k )} \} , \qquad ( 6.20 )$$

where F⁻¹ denotes the inverse Fourier transform, and Sᵢₛ(k) and Sᵢᵢ(k) are the complex envelopes of the cross- and auto-power spectra, respectively.

6.3.1.2 Depth-Resolved Spectral Estimation

The sample transfer function |H(k)|² which may be obtained from the Fourier trasnsform of equation 6.19 describes the backscatter spectral characteristic of the sample, i.e. the ratio of the backscattered power spectrum to the spectrum which was incident. However, since the coherence length in an OCT system is short, it is possible to use an analog of time-frequency analysis methods [49] to extract the backscatter characteristic with depth discrimination. This can be accomplished by limiting the detected transfer function data to the region of interest in the sample by digitally windowing the auto- and cross-correlation data used to calculate |H(k)|². This is the short-time Fourier transform [50] technique; wavelet transform [51] approaches may also be used.

All information regarding the spatial and frequency dependence of scattering within the sample is contained in the complex space domain function h(z) and its Fourier transform H(k). If the windowed region contains only a single scatterer, |H(k)|² is straightforwardly interpreted as the wavenumber-dependent backscatter characteristic of that scatterer, denoted |C(k)|². In a medium containing many identical scatterers, the impulse response h(z) windowed to the region of interest may be modeled as being a convolution of two new functions: h(z)=b(z) [symbol] c(z). Here, b(z) describes the spatial distribution of scatterers along the sample axis z, and c(z) is the inverse Fourier transform of C(k). Under the assumption that b(z) is a white stochastic process (i.e., the scatterer locations are uncorrelated), the expectation value of |H(k)|² is then given by:

E{|H(k)|²}=E{|B(k)|²}|C(k)|²=|C(k)|², (6.21)

where B(k) is the Fourier transform of b(z). Thus, the backscatter characteristic of the individual scatterers in a sample may be directly obtained within a user-selected region of the sample by appropriate Fourier-domain averaging of coherently detected windowed interferogram data. This analysis is readily extended to the case of a medium containing a heterogenous mixture of scatterers, each having its own backscatter characteristic. In this case, a similar signal processing algorithm produces an estimated spectrum corresponding to a weighted average of the individual backscatter spectra [45].

One final step allows for estimation of the actual backscattered spectrum of light returning from the sample rather than the backscatter transfer characteristic of the scatterers. Since the spectrum of light in the sample arm is defined as \tilde{S}ₛₛ(k)=\tilde{E}ₛ(k)\tilde{E}*ₛ(k), using \tilde{E}ₛ(k)=\tilde{E}ᵢ(k)\tilde{H}*(k) (the modulated analog of equation 6.17) gives \tilde{S}ₛₛ(k)=|\tilde{S}ᵢₛ(k)|²/\tilde{S}ᵢᵢ(k). Similar to the previous paragraph, ensemble averaging must be used in order to average out apparent spectral features which are really due to the spatial structure of the scatterer distribution:

\tilde{S}ₛₛ(k)=E{|\tilde{S}ᵢₛ(k)|²}/\tilde{S}ᵢᵢ(k). (6.22)

6.3.2 OCT Image Deconvolution

6.3.2.1 Straightforward Approach

The systems theory model described in the previous section predicts that the optical impulse response of tissue h(z) or \tilde{h}(z) is calculable if the complete cross-correlation sequence comprising the OCT signal is acquired with interferometric accuracy. The impulse response is interpreted as describing the actual locations and amplitudes of scattering sites within the sample arising from index of refraction inhomogeneities and particulate scatterers.

An example of the application of Eq. (6.20) for direct deconvolution of undemodulated OCT A-scan data is provided in FIG. 6.16. This data was acquired using a data acquisition system with interferometric calibration capable of capturing the crosscorrelation sequence with nanometer spatial resolution [24]. An interferogram segment obtained with this system which includes several discrete reflections is plotted in the figure. Also plotted in the figure are the autocorrelation sequence from a mirror reflection, and the impulse response calculated using the modulated analog of Eq. (6.20). An increase in resolution by a factor of >2 was obtained between the original interferogram and the calculated impulse response profile. The improvement obtained using this simple, no-cost algorithm is quite striking when executed on two-dimensional data sets, as illustrated in FIG. 6.17(a-b). In this figure, digital deconvolution of magnitude-only demodulated A-scan data was used to improve image sharpness in the axial (vertical) direction of a cross-sectional OCT image of a fresh onion specimen.

The data used as the input for the deconvolution algorithm in FIG. 6.17a was acquired using an OCT system which, like most OCT systems constructed to date and most other biomedical imaging modalities (excluding ultrasound), records only the magnitude of the image data. A novel approach to signal deconvolution which takes advantage of the complex nature of OCT signals is to perform coherent deconvolution by supplying both the magnitude and phase of the demodulated A-scan data as complex inputs to the deconvolution equation. The advantage of this approach is illustrated in FIG. 6.18, which illustrates the capability of coherent deconvolution to extract real sample features from what would have been regarded as meaningless speckle in amplitude-only data.

6.3.2.2 Iterative Restoration Methods

The practical implementation of Fourier-domain deconvolution algorithms such as described by Eq. (6.20) inevitably leads to a reduction in image dynamic range, as evidenced in FIG. 6.17(b). This is because even small errors in the estimation of the auto- and cross-correlation spectra introduce noise in the resulting impulse response image due to the division operation inherent to deconvolution. In order to alleviate this problem, one study [48] has applied advanced constrained iterative deconvolution algorithms [52] to the OCT deconvolution problem. In these algorithms, improved restoration of the impulse response from the cross-correlation data is achieved by using prior knowledge of the properties of the desired impulse response. This usage of a priori knowledge provides a consistent extrapolation of spectral components of the transfer function beyond the source bandwidth. The impulse response is then estimated by the method of successive approximations, hence no division operation leading to instabilities and noise is involved. Therefore, the iterative algorithms offer the potential to achieve improvement in OCT resolution with a minimal increase in noise. In a test applying this algorithm to the same onion image data set displayed in FIG. 6.17(a), resolution enhancement similar to that displayed with the straightforward deconvolution algorithm was achieved, but with much smaller dynamic range loss (˜2 dB; see FIG. 6.17(c)).

6.3.2.2 CLEAN Algorithm

One report has described promising results in deconvolution of OCT images using the CLEAN algorithm [44]. This algorithm, which is highly nonlinear and can only be described algorithmically, begins with an estimate of a system's impulse response. It then searches a dataset for a peak, subtracts the impulse response from the data set at the location of the peak, and places a delta function at the location of the peak in the deconvolved dataset. Using a modified version of this algorithm, Schmitt demonstrated somewhat improved resolution and clarity in OCT images of phantoms and skin.

6.3.3 Spectroscopic OCT

Although most OCT systems developed to date have used light exclusively to probe the internal microstructure of sample specimens, the possibility of extracting spectroscopic information from OCT signals is particularly exciting since it may provide access to additional information about the composition and functional state of samples. Relatively little work has been published to date on this topic, primarily because the number of spectral regions in which sources suitable for OCT are quite limited, and because the spectral bandwidth of OCT sources are quite narrow compared to light sources used in conventional spectroscopy.

Efforts to date on spectroscopic OCT have concentrated in two areas. First, a few reports have appeared concerning spectral ratio imaging of OCT images acquired at two or more spectral bands [53, 54]. This approach can be implemented most elegantly by using a wavelength division multiplexer (WDM) to combine light from two or more sources into the source fiber, and then electronically distinguishing the resulting signals by their different Doppler shifts resulting from the reference arm scan. Of course, this approach is limited to a choice of wavelengths which can simultaneously be mode guided in a single-mode fiber. Ratiometric OCT imaging using a pair of sources at 1.3 and 1.5 microns (which are separated by approximately one decade in water absorption coefficient, but have similar scattering coefficients in tissues) has been used to probe the water content of samples in three dimensions [53]. Combinations of other wavelength pairs have also been attempted in search of contrast in biological tissues [54].

The second implementation of spectroscopic OCT is that described in section 6.3.1.2 above, in which modifications of the source spectrum caused by the sample may be measured directly from Fourier-domain processing of cross-correlation interferometric data. The most successful application of this idea to date has been in Doppler OCT, in which spatially resolved shifts in the sample spectrum due to sample motion are estimated from localized spectral shifts in the cross-correlation data [34, 35]. Details of the signal processing techniques used to extract this data and some preliminary applications are described in the Doppler OCT chapter.

Even if sample motion is absent, however, the techniques described in section 6.3.1.2 may still be used to extract useful spectral information from samples [25, 37]. A simple example of depth-resolved spectroscopy using OCT is provided in FIG. 6.19. Here, the backscatter spectral characteristic |H(k)|² of sample arm light reflected from the front and back surfaces (the latter having double-passed the filter) of a commercial interference filter are plotted. These quantities were obtained by applying the Fourier transform of equation 6.19 to an OCT A-scan of the filter, windowed to the vicinity of the glass-air reflection from the front and rear sides of the filter. It is interesting to note that this data illustrate quantitative depth-resolved reflectance spectroscopy demonstrating the equivalent of femtosecond temporal resolution in a simple, inexpensive system suitable for biomedical applications.

6.4 Safety in the Clinical Environment

An important consideration in the implementation of OCT systems for medical diagnostic applications is the issue of operator and patient safety. All hospitals in the United States and most research funding agencies and foundations require Institutional Review Board (IRB) approval of all studies involving human tissues, including excised tissue samples. IRB approval procedures typically include the review of procedures for informed consent of patients who will be used as experimental subjects. Potential hazards to operators of OCT equipment and to patients fall into three categories: biohazards, medical device electrical safety, and optical radiation hazards. Procedures for avoidance of contamination and infection, as well as for electrical safety are well established in hospital environments, although they may not be as familiar to researchers with physical science backgrounds. Biohazard avoidance primarily means utilization of proper procedures for handling potentially infected tissues, as well as proper disinfection of probes and other devices which come into contact with patients or tissue samples. Electrical device safety guidelines typically regulate the maximum current which a patient or operator may draw by touching any exposed part of a medical device, and are usually followed by including appropriate electrical isolation and shielding into the design of clinical OCT systems (see, for example, [55]).

6.4.1 Optical Radiation Hazards in OCT

A potential operator and (primarily) patient safety concern which is unique to optical biomedical diagnostics devices is the potential for exposure to optical radiation hazards. Although cw sources used for OCT are typically very weak compared to lasers used in physical science laboratories and even in other medical applications, the tight focussing of OCT probe beams which is required for high spatial image resolution does produce intensities approaching established optical exposure limits. A number of international bodies recommend human exposure limits for optical radiation; in the United States, one well-known set of guidelines for optical radiation hazards are produced by the American National Standards Institute, ANSI Z136.1 [56]. Unfortunately, these guidelines are specified for laser radiation exposure, and are also provided only for exposures to the eye and skin. Nonetheless, many analyses of OCT radiation safety have utilized these standards. The applicable ANSI standards for cw laser exposure to the eye and skin both recommend a maximum permissible exposure (MPE) expressed as a radiant exposure, which is a function of the exposure duration, and tabulated spectral correction factors.

The following references are hereby incorporated herein in their entirety.

References

1. Sorin, W. V. and D. M. Baney, A Simple Intensity Noise Reduction Technique for Optical Low-Coherence Reflectometry. IEEE Photonics Technology Letters, 1992. 4(12): p. 1404-1406.

2. Rollins, A. M. and J. A. Izatt, Optimal interferometer designs for optical coherence tomography. Optics Letters, 1999. in press.

3. Bouma, B. E. and G. J. Tearney, Power-efficient nonreciprocal interferomeier and linear-scanning fiber-optic catheter for optical coherence tomography. Optics Letters, 1999. 24(8): p. 531-533.

4. Abbas, G. L., V. W. S. Chan and T. K. Yee, Local-oscillator excess-noise suppression for homodyne and heterodyne detection. Optics Letters, 1983. 8(8): p. 419-421.

5. Agrawal, G. P., Fiber-Optic Communication Systems. Wiley Series in Microwave and Optical Engineering, ed. K. Chang. 1992, New York, N.Y.: John Wiley & Sons, Inc.

6. Takada, K., Noise in Optical Low-Coherence Reflectometry. IEEE Journal of Quantum Electronics, 1998.34(7): p. 1098-1108.

7. Hee, M. R., J. A. Izatt, J. M. Jacobson, E. A. Swanson and J. G. Fujimoto, Femtosecond Transillumination Optical Coherence Tomography. Opt. Lett., 1993. 18: p. 950.

8. Podoleanu, A. G. and D. A. Jackson, Noise analysis of a combined optical coherence tomograph and a confocal scanning ophthalmoscope. Applied Optics, 1999. 38(10): p. 2116-2127.

9. Rollins, A. M., R. Ung-Arunyawee, A. Chak, R. C. K. Wong, K. Kobayashi, J. Michael V Sivak and J. A. Izatt, Real-time in vivo imaging of human gastrointestinal ultrastructure using endoscopic optical coherence tomography with a novel efficient interferometer design. Optics Letters, 1999. in press.

10. Rollins, A. M., S. Yazdanfar, R. Ung-arunyawee and J. A. Izatt. Real-Time Color Doppler Optical Coherence Tomography Using and Autocorrelation Technique. in Coherence Domain Optical Methods in Biomedical Science and Clinical Applications III. 1999. San Jose, Calif.: Society of Photo-Instrumentation Engineers.

11. Swanson, E. A., D. Huang, M. R. Hee, J. G. Fujimoto, C. P. Lin and C. A. Puliafito, High Speed Optical Coherence Domain Reflectometry. Opt. Lett., 1993. 18: p. 1864.

12. Swanson, E. A., J. A. Izatt, M. R. Hee, D. Huang, C. P. Lin, J. S. Schuman, C. A. Puliafito, and J. G. Fujimoto, In vivo retinal imaging by optical coherence tomography.

Opt. Lett., 1993. 18(21): p. 1864-1866.

13. Izatt, J. A., M. D. Kulkarni, H. -W. Wang, K. Kobayashi and M. V. Sivak, Optical Coherence Tomography and Microscopy in Gastrointestinal Tissues. IEEE Journal of Selected Topics in Quantum Electronics, 1996. 2(4): p. 1017-1028.

14. Izatt, J. A., M. D. Kulkarni, K. Kobayashi, M. V. Sivak, J. K. Barton and A. J. Welch, Optical Coherence Tomography for Biodiagnostics. Optics and Photonics News, 1997. 8: p. 41-47.

15. Tearney, G. J., B. E. Bouma, S. A. Boppart, B. Golubovic, E. A. Swanson and J. G. Fujimoto, Rapid Acquisition of In Vivo Biological Images by Use of Optical Coherence Tomography. Optics Letters, 1996. 21(17): p. 1408-1410.

16. Tearney, G. J., B. E. Bouma and J. G. Fujimoto, High Speed Phase- and Group-Delay Scanning with a Grating-Based Phase Control Delay Line. Optics Letters, 1997. 22(23): p. 1811-1813.

17. Sergeev, A. M., V. M. Gelikonov, G. V. Gelikonov, F. I. Feldchtein, R. V. Kuranov, N. D. Gladkova, N. M. Shakhova, L. B. Snopova, A. V. Shakhov, I. A. Kuznetzova, A. N. Denisenko, V. V. Pochinko, Y. P. Chumakov and O. S. Streltzova, In Vivo Endoscopic OCT Imaging of Precancer and Cancer States of Human Mucosa. Optics Express, 1997. 1(13): p. 432-440.

18. Rollins, A. M., M. D. Kulkarni, S. Yazdanfar, R. Un-arunyawee and J. A. Izatt, In vivo Video Rate Optical Coherence Tomography. Optics Express, 1998. 3(6): p. 219-229.

19. Iuang, D., E. A. Swanson, C. P. Lin, J. S. Schuman, W. G. Stinson, W. Chang, M. R. Hee, T. Flotte, K. Gregory, C. A. Puliafito and J. G. Fujimoto, Optical Coherence Tomography. Science, 1991. 254: p. 1178-1181.

20. Izatt, J. A., M. R. Hee, E. A. Swanson, C. P. Lin, D. Huang, J. S. Schuman, C. A. Puliafito and J. G. Fujimoto, Micrometer-Scale Resolution Imaging of the Anterior Eye In Vivo With Optical Coherence Tomography. Archives of Ophthalmology, 1994. 112: p. 1584-1589.

21. Chinn, S. R., E. A. Swanson and J. G. Fujimoto, Optical coherence tomography using a frequency-tunable optical source. Optics Letters, 1997. 22(5): p. 340-342.

22. Windecker, R., M. Fleischer, B. Franze and H. J. Tiziani, Two Methods for Fast Coherence Tomography and Topometry. Journal of Modem Optics, 1997. 44(5): p. 967-977.

23. Szydlo, J., N. Delachenal, R. Gianotti, R. Walti, H. Bleuler and R. P. Salathe, Air-turbine driven optical low-coherence reflectometry at 28.6-kHz scan repetition rate. Optics Communications, 1998.154: p. 1-4.

24. Kulkarni, M. D. and J. A. Izatt. Digital Signal Processing in Optical Coherence Tomography. in Coherence Domain Optical Methods in Biomedical Science and Clinical Applications. 1997. San Jose, SA: Society of Photo-Instrumentation Engineers.

25. Kulkarni, M. D. and J. A. Izatt. Spectroscopic Optical Coherence Tomography. in Conference on Lasers and Electro-Optics. 1996: Optical Society of America, Washington D.C.

26. Podoleanu, A. G., M. Seeger, G. M. Dobre, D. J. Webb, D. A. Jackson and F. W. Fitzke, Transversal and Longitudinal Images from the Retina of the Living Eye Using Low Coherence Reflectometry. Journal of Biomedical Optics, 1998. 3(1): p. 12-20.

27. Podoleanu, A. G., G. M. Dobre and D. A. Jackson, En-face coherence imaging using galvanometer scanner modulation. Optics Letters, 1998.23(3): p. 147-149.

28. Izatt, J. A., M. R. Hee, G. A. Owen, E. A. Swanson and J. G. Fujimoto, Optical Coherence Microscopy in Scattering Media. Opt. Lett., 1994. 19: p. 590-592.

29. Bashkansky, M., M. D. Duncan, M. Kahn, D. L. III and J. Reintjes, Subsurface defect detection in ceramics by high-speed high-resolution optical coherent tomography. Optics Express, 1997. 22(1): p. 61-63.

30. Fercher, A. F., C. K. Hitzenberger, W. Drexler, G. Kamp and H. Sattmann, In Vivo Optical Coherence Tomography. American Journal of Ophthalmology, 1993. 116(1): p. 113-114.

31. Schmitt, J. M., M. J. Yadlowsky and R. F. Bonner, Subsurface Imaging of Living Skin with Optical Coherence Microscopy. Dermatology, 1995. 191: p. 93-98.

32. Fujimoto, J. G., M. E. Brezinsky, G. J. Tearney, S. A. Boppart, B. Bouma, M. R. Hee, J. F. Southern and E. A. Swanson, Optical Biopsy and Imaging Using Optical Coherence Tomography. Nature Medicine, 1995. 1: p. 970-972.

33. Tearney, G. J., M. E. Brezinski, B. E. Bouma, S. A. Boppart, C. Pitris, J. F. Southern and J. G. Fujimoto, In Vivo Endoscopic Optical Biopsy with Optical Coherence Tomography. Science, 1997.276: p. 2037-2039.

34. Chen, Z., T. E. Milner, S. Srinivas, X. Wang, A. Malekafzali, M. J. C. van Gemert and J. S. Nelson, Noninvasive Imaging of In Vivo Blood Flow Velocity Using Optical Doppler Tomography. Opt. Lett., 1997. 22: p. 1119-1121.

35. Izatt, J. A., M. D. Kulkami, S. Yazdanfar, J. K. Barton and A. J. Welch, In Vivo Bidirectional Color Doppler Flow Imaging of Picoliter Blood Volumes Using Optical Coherence Tomography. Optics Letters, 1997. 22(18): p. 1439-1441.

36. de Boer, J. F., T. E. Milner, M. J. C. van Gemert and J. S. Nelson, Two-Dimensional Birefringence Imaging in Biological Tissue by Polarization-Sensitive Optical Coherence Tomography. Optics Letters, 1997. 22: p. 934-936.

37. Morgner, U. Spectroscopic Optical Coherence Tomography. in Conference on Lasers and Electro-Optics. 1999. Baltimore, Md.: Optical Society of America.

38. Gonzalez, R. C. and R. E. Woods, Digital Image Processing. 1992, Reading, Mass.: Addison-Wesley Publishing Co.

39. Wolberg, G., Digital Image Warping. 1994, Los Alamitos, Calif.: IEEE Computer Society Press.

40. Teamey, G. J., S. A. Boppart, B. E. Bouma, M. E. Brezinsky, N. J. Weissman, J. F. Southern and J. G. Fujimoto, Scanning Single-Mode Fiber Optic Catheter-Endoscope for Optical Coherence Tomography. Opt. Lett., 1996. 21: p. 543-545.

41. Hee, M. R., J. A. Izatt, E. A. Swanson, D. Huang, J. S. Schuman, C. P. Lin, C. A. Puliafito and J. G. Fujimoto, Optical Coherence Tomography for Micron-Resolution Ophthalmic Imaging, in IEEE Eng. Med Biol. Mag. 1995. p. 67-76.

42. Yazdanfar, S., A. M. Rollins and J. A. Izatt. In Vivo Imaging of Blood Flow in Human Retinal Vessels Using Color Doppler Optical Coherence Tomography. in Coherence Domain Methods in Biomedical Science and Clinical Applications III. 1999. San Jose, Calif.: Society of Photo-Instrumentation Engineers.

43. Pan, Y., R. Bimgruber, J. Rosperich and R. Engelhardt, Low-Coherence Optical Tomography in Turbid Tissue: Theoretical Analysis. Appl. Opt., 1995. 34: p. 6564-6574.

44. Schmitt, J. M., Restoration of Optical Coherence Images of Living Tissue Using the CLEAN Algorithm. Journal of Biomedical Optics, 1998.3(1): p. 66-75.

45. Kulkarni, M. D., Coherent Signal Processing in Optical Coherence Tomography, in Biomedical Engineering. 1999, Case Western Reserve University: Cleveland, Ohio.

46. Papoulis, A., Systems and Transforms with Applications in Optics. 1968, New York: McGraw-Hill.

47. Mendel, J. M., Maximum-likelihood deconvolution: a journey into model-based signal processing. 1990, New York: Springer-Verlag.

48. Kulkarni, M. D., C. W. Thomas and J. A. Izatt, Image Enhancement in Optical Coherence Tomography Using Deconvolution. Electronics Letters, 1997. 33(16): p. 1365-1367.

49. Cohen, L., Time-Frequency Analysis. Prentice Hall Signal Processing Series, ed. A. V.

Oppenheim. 1995, Englewood Cliffs, N.J.: Prentice Hall.

50. Nawab, S. H., and T. F. Quatieri, Short-Time Fourier Transform, in Advanced topics in signal processing, J. S. L. a. A. V. Oppenheim, Editor. 1989, Prentice Hall: Englewood Cliffs, N.J. p. 289-327.

51. Mallat, S. G., A Theory for Multiresolution Signal Decomposition: The Wavelet Representation. IEEE Transactions on Pattern Analysis and Machine Intelligence, 1989. 11(7): p. 674-693.

52. Schafer, R. W., R. M. Mersereau and M. A. Richards, Constrained Iterative Restoration Algorithms. Proceedings of the IEEE, 1981. 69: p. 432.

53. Schmitt, J. M., S. H. Xiang and K. M. Yung, Differential Absorption Imaging with Optical Coherence Tomography. J. Opt. Soc. Am. A, 1998. 15: p. 2288-2296.

54. Pan, Y. and D. L. Farkas, Noninvasive Imaging of Living Human Skin With Dual-Wavelength Optical Coherence Tomography in Two and Three Dimensions. J. Biomed. Opt., 1998.3: p. 446-455.

55. Olson, W. H., Electrical Safety, in Medical Instrumentation, J. G. Webster, Editor. 1995, John Wiley & Sons, Inc.: New York, N.Y. p. 751-792.

56. American National Standard for Safe Use of Lasers, . 1993, American National Standards Institute: New York, N.Y. p. 37-43.

57. Hee, M. R., J. A. Izatt, E. A. Swanson, D. Huang, J. S. Schuman, C. P. Lin, C. A. Puliafito and J. G. Fujimoto, Optical Coherence Tomography of the Human Retina. Arch. Ophthalmol., 1995. 113: p. 325-332.

### MULTISTEP IMAGE DEWARPING OF OCT IMAGES USING FERMAT'S PRINCIPLE AND MAPPING ARRAYS

All transformations will be carried out as back-transformations, meaning we determine for a given position (xₜ, yₜ) in the target image the position (xᵣ, yᵣ) in the raw data acquired by the frame grabber. In general we will use x for coordinates perpendicular to the A-scans and y for coordinates in line with the A-scans. For simplification, all coordinate systems have the origin in the center of the image. Pₓₓₓ is an abbreviation of (xₓₓₓ, yₓₓₓ). Dimensions of images are given in n pixels wide and m pixels high.

Very often in imaging data is acquired as rows and columns in a rectangular image. In many cases, this raw image has not the true aspect ratio, or more general, the resulting target image can have any shape. There are two ways to map the data from the raw image onto the target image. The forward transformations

xₜ=fₓₜ(xᵣ,yᵣ)

yₜ=f_{yt}(xᵣ,yᵣ) (1.)

assign the point (xₜ, yₜ) in the target image to where the pixel data at (xᵣ, yᵣ) will correspond to. In general, (xₜ, yₜ) won't be at an integer position, therefore the value at (xᵣ, yᵣ) has to be distributed on the neighboring pixels. The weights are not so easy to determine, especially if many raw pixels will be mapped to a small area in the target image. The image has to be normalized against the pixel density. With the backward transformation

xᵣ=fₓᵣ(xₜ,yₜ)

yᵣ=f_{yr}(xₜ,yₜ) (2.)

the algorithm calculates for each pixel (xₜ, yₜ) in the target image the corresponding position (xᵣ, yᵣ) in the raw image. If this position is not at a exact pixel, there are several ways to assign a value. The fastest ways would be the ‘next neighbor’, assigning the target pixel the value of the closest neighbor pixel of (xᵣ, yᵣ) in the raw image. Higher precision can be obtained through bilinear interpolation between the four neighboring pixels. Other methods are trilinear or spline interpolation.

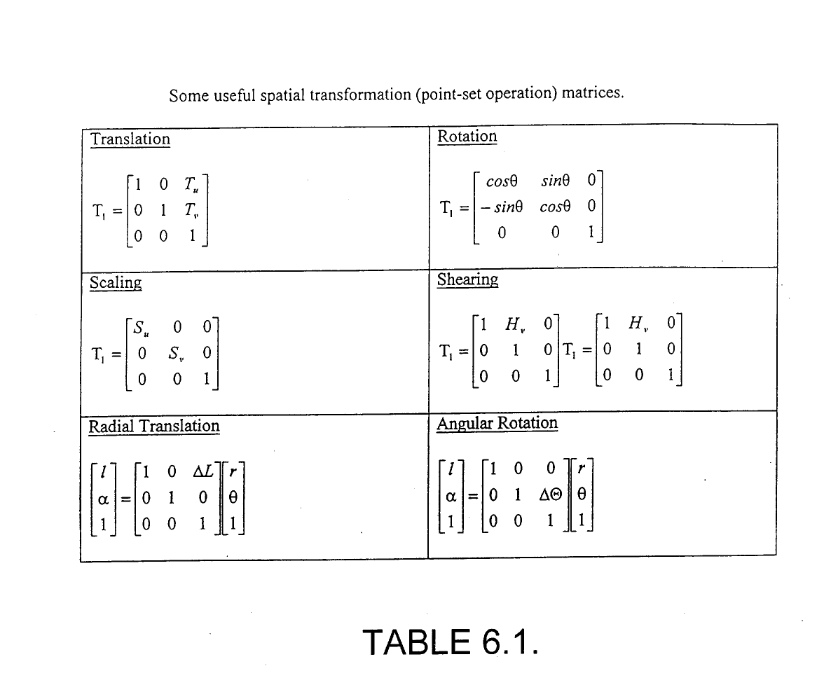

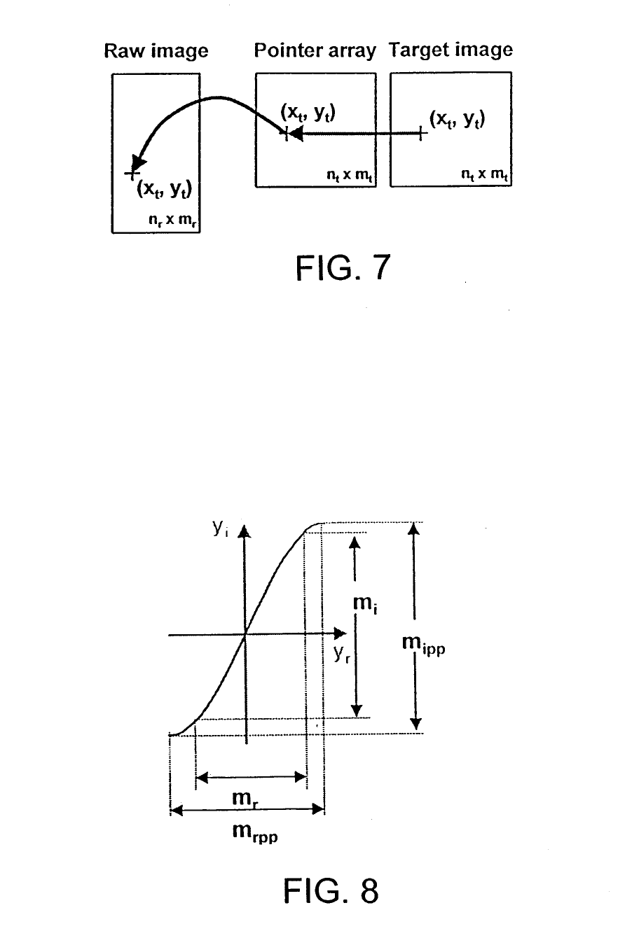

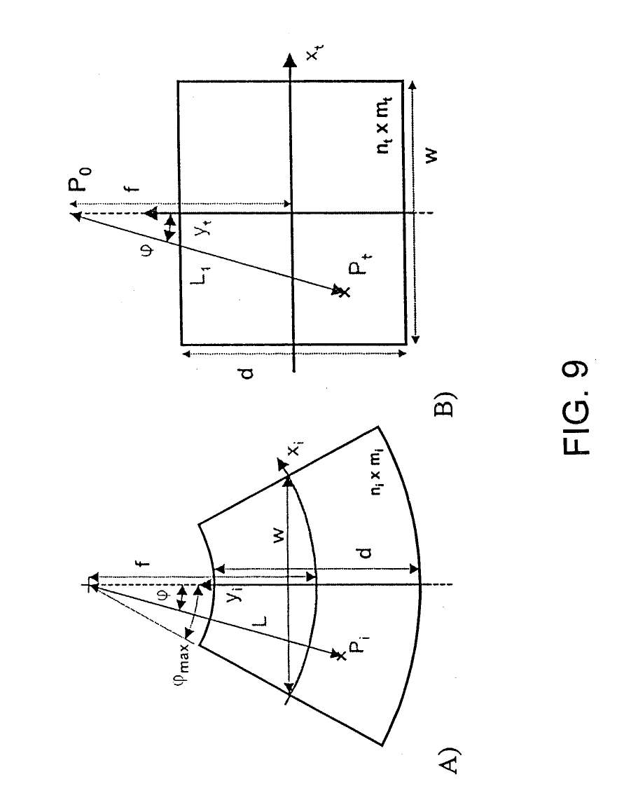

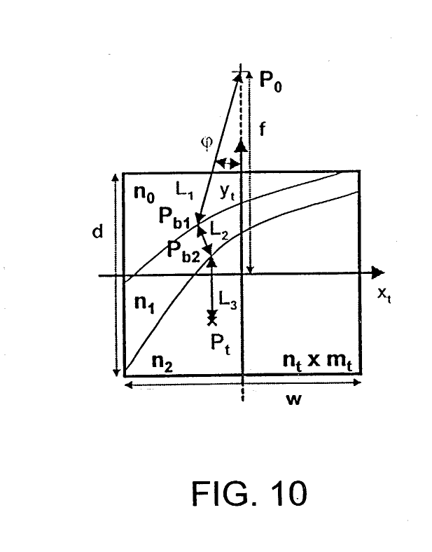

To do these transformation each time an image is acquired is, depending on the transformation, computational expensive. We are showing here a method that allows real-time image transformation using a mapping array and the next neighbor interpolation. The mapping array is an array of pointers, with the same number of rows and columns as the target image. If fₓᵣ and f_{yr} are constant or seldom, the values of this array can be precalculated. The pointer at the position (xₜ, yₜ) will be assigned the address of the corresponding rounded pixel at the rounded position (xᵣ, yᵣ). Once this has been done for all target pixels the image transformation can be done very quickly. To get the value for each target pixel the algorithm uses the corresponding pointer to access the pixel in the raw image (cf. FIG. 7). Even complicated fₓᵣ and f_{yr} do not slow down the imaging rate.

8 Polar Image

This technique is used in combination with the endoscopic probe. With this probe A-scans are taken in a radial fashion, with the probe constantly rotating. Therefore xᵣ and yᵣ are rather polar coordinates:

$$R ( {x}_{r} ) = \frac{{x}_{r}}{{n}_{r}} + \frac{{r}_{probe} + \frac{d}{2}}{d} \\ θ ( {y}_{r} ) = 2 π \frac{{y}_{r}}{{m}_{r}} \qquad ( 3. a , b )$$

with the radius r_{probe} of the probe and the imaging depth d. R and θ are dimensionless. They can also be expressed in target coordinates

$$R ( {x}_{t} , {y}_{t} ) = \frac{\sqrt{{x}_{t}^{2} + {y}_{t}^{2}} }{{n}_{t} / 2} \frac{{r}_{probe} + d}{d} \\ θ ( {x}_{t} , {y}_{t} ) = arctan ( \frac{{y}_{t}}{{x}_{t}} ) \qquad ( 4. a , b )$$

By combining Eq. 3. and Eq. 4. the backward transformations can be obtained

$${x}_{r} = ( \frac{\sqrt{{x}_{t}^{2} + {y}_{t}^{2}} }{{n}_{t} / 2} \frac{{r}_{probe} + d}{d} - \frac{{r}_{probe} + \frac{d}{2}}{d} ) {n}_{r} \\ {y}_{r} = \frac{{m}_{r}}{2 π} arctan ( \frac{{y}_{t}}{{x}_{t}} ) \qquad ( 5. a , b )$$

The image acquired by the frame grabber is called the raw image, with r as an index to define coordinates. Due to the sinusoidal motion of the reference arm mirror this image is deformed along the direction of the A-scan. Therefore the first transformation necessary is from raw image coordinates

The raw image is captured with nᵣ pixels per A-scan and mᵣ A-scans. In principle there would be nᵣₚₚ pixel (peak to peak) available in an A-scan, therefore the duty cycle η is defined as

$$η = \frac{{n}_{r}}{{n}_{rpp}} \qquad ( 6. )$$

The forward transformation from raw (xᵣ, yᵣ) into intermediate (xᵢ, yᵢ) coordinates is defined as

$${x}_{i} ( {y}_{r} ) = {y}_{r} \frac{{n}_{i}}{{m}_{r}} \\ {y}_{i} ( {x}_{r} ) = \frac{{m}_{ipp}}{2} sin ( \frac{2 π}{2 {n}_{rpp}} {x}_{r} ) \qquad ( 7. a , b )$$

with the full peak to peak amplitude mᵢₚₚ of the A-scan in the intermediate coordinates. Because η<100% only part of the full sinusoidal motion is visible, the intermediate image span mᵢ pixel in depth. mᵢₚₚ can be calculated from

$$\begin{matrix}{y}_{i} ( \frac{{n}_{r}}{2} ) = \frac{{m}_{ipp}}{2} sin ( \frac{π}{{n}_{rpp}} \frac{{n}_{r}}{2} ) = \frac{{m}_{i}}{2} \\ ⇒ {m}_{ipp} = \frac{{m}_{i}}{sin ( \frac{π}{2} η )}\end{matrix} \qquad ( 8. )$$

Therefore the back-transformation will be as follows

$${x}_{r} ( {y}_{i} ) = \frac{{n}_{rpp}}{π} arcsin ( \frac{2 {y}_{i}}{{m}_{ipp}} ) \\ {y}_{r} ( {x}_{i} ) = {x}_{i} \frac{{m}_{r}}{{n}_{i}} \qquad ( 9. a , b )$$

8.1 Application on Radially Scanning Probe

For the combination of the polar image with the sinusoidal scanning Eq. 7. has to be inserted into Eq. 3.:

$$\begin{matrix}R ( {x}_{r} ) = \frac{{m}_{ipp} sin ( \frac{π}{{n}_{rpp}} {x}_{r} )}{2 {m}_{i}} + \frac{{r}_{probe} + \frac{d}{2}}{d} \\ = \frac{sin ( \frac{π}{{n}_{rpp}} {x}_{r} )}{2 sin ( \frac{π}{2} η )} + \frac{{r}_{probe} + \frac{d}{2}}{d}\end{matrix} \\ θ ( {y}_{r} ) = 2 π \frac{{y}_{r}}{{m}_{r}} \qquad ( 10. a , b )$$

This we can set equal with Eq. 4. and obtain

$${x}_{r} = \frac{2 {n}_{rpp}}{π} arcsin [ 2 sin ( \frac{π}{2} η ) ( \frac{\sqrt{{x}_{t}^{2} + {y}_{t}^{2}}}{{n}_{t} / 2} \frac{{r}_{probe} + d}{d} - \frac{{r}_{probe} + \frac{d}{2}}{d} ) ] \\ {y}_{r} = \frac{{m}_{r}}{2 π} arctan ( \frac{{y}_{t}}{{x}_{t}} ) \qquad ( 11. a , b )$$

When the handheld probe takes a B-scan, the scans emerges diverging from the final lens. The center of the image is aligned to be a focal length f away from this lens. The image scans a width w in the vertical center of the image and the scan depth d is measured in the horizontal center. The A-scans are emerging radially from the focus, the pixel being narrower on top of the image than on the bottom. xᵢ and yᵢ are in kind of polar coordinates. In these coordinates, the angle φ and the distance L from the lens are defined in terms of the point Pᵢ=(xᵢ, yᵢ)

$$\begin{matrix}ϕ ( {x}_{i} ) = {ϕ}_{max} \frac{{x}_{i}}{{n}_{i} / 2} & with {ϕ}_{max} = arcsin ( \frac{w}{2 f} ) \\ L ( {y}_{i} ) = \frac{{f}_{i} - {y}_{i}}{{m}_{i}} & with {f}_{i} = f \frac{{m}_{i}}{d}\end{matrix} \qquad ( 12. a , b )$$

L is made dimensionless by dividing through mᵢ. These φ and L can also be calculated for the target image:

$$\begin{matrix}ϕ ( {x}_{t} , {y}_{t} ) = arctan ( \frac{{x}_{t}}{{f}_{t} - {y}_{t}} ) & with {f}_{t} = f \frac{{m}_{t}}{d} \\ L ( {x}_{t} , {y}_{t} ) = \frac{\sqrt{{x}_{t}^{2} + {( {f}_{t} - {y}_{t} )}^{2}}}{{m}_{t}} & \end{matrix} , \qquad ( 13. a , b )$$

with L being dimensionless as well. φ and L can be set equal with Eq. 12. and these equations can be solved for (xᵢ, yᵢ):

$${x}_{i} ( {x}_{t} , {y}_{t} ) = \frac{{n}_{i}}{2 {ϕ}_{max}} arctan ( \frac{{x}_{t}}{{f}_{t} - {y}_{t}} ) \\ {y}_{i} ( {x}_{t} , {y}_{t} ) = {f}_{i} - \sqrt{{x}_{t}^{2} + {( {f}_{t} - {y}_{t} )}^{2}} \frac{{m}_{i}}{{m}_{t}} \qquad ( 14. a , b )$$

This transformation can be combined with the correction of the nonlinear scanning of the reference arm (Eq. 9.):

$${x}_{r} ( {x}_{t} , {y}_{t} ) = \frac{{n}_{rpp}}{π} arcsin ( 2 \frac{{f}_{i} {m}_{t} - \sqrt{{x}_{t}^{2} + {( {f}_{t} - {y}_{t} )}^{2}} {m}_{i}}{{m}_{ipp} {m}_{t}} ) \\ {y}_{r} ( {x}_{t} , {y}_{t} ) = \frac{{m}_{r}}{2 {ϕ}_{max}} arctan ( \frac{{x}_{t}}{{f}_{t} - {y}_{t}} ) \qquad ( 15. a , b )$$

These equations are not dependant on the image content; therefore this transformation can be realized as a mapping area, allowing for real-time imaging.

If the medium that has been imaged is non-homogeneous in the index of refraction, refraction occurs. In the following, we assume that there are two smooth boundaries between different media in the area imaged, with an index of refraction of n₀=1 (air) on top, followed by two layers with the indices n₁ and n₂. This can easily be expanded to several layers, in the expense of more computation time. In the current state the user defined the boundaries by a few points, which are than connected through a spline. The forward transformation would use Snell's law to calculate the target pixel given the raw data pixel. But for the back-transformation Fermat's principle has to be applied. It states that the light would always take the shortest path between the source and the target. In our case,

L(xₜ,yₜ,x_{b1},y_{b1},x_{b2},y_{b2})=L₁(x_{b1},y_{b1})+L₂(x_{b1},y_{b1},x_{b2},y_{b2})+L₃(x_{b2},y_{b2},xₜ,yₜ) (16.)

has to be minimal. L₁, L₂, L₃ are defined as

$${L}_{1} ( {x}_{b1} , {y}_{b1} ) = \frac{\sqrt{{x}_{b1}^{2} + {( {f}_{t} - {y}_{b1} )}^{2}}}{{m}_{t}} {n}_{0} \\ {L}_{2} ( {x}_{b1} , {y}_{b1} , {x}_{b2} , {y}_{b2} ) = \frac{\sqrt{( {x}_{b1} - {x}_{b2} ) + {( {y}_{b1} - {y}_{b2} )}^{2}}}{{m}_{t}} {n}_{1} \\ {L}_{3} ( {x}_{b2} , {y}_{b2} , {x}_{t} , {y}_{t} ) = \frac{\sqrt{( {x}_{t} - {x}_{b2} ) + {( {y}_{t} - {y}_{b2} )}^{2}}}{{m}_{t}} {n}_{2} \qquad ( 17. a , b , c )$$

y_{b1} and y_{b2} are functions of x_{b1} and x_{b2}, given by the user defined splines. Unfortunately, x_{b1} and x_{b2} are unknown and had to be found through an optimization process to minimize L, which is computational intensive. Assuming that x_{b1} and x_{b2} are not varying a lot between subsequent lines in the target image, this optimization can be simplified by taking the previous value as a seed and to look for the shortest path length if x_{b1} and x_{b2} are varied in steps of 0.1 pixel in the neighborhood of 0.5 pixel. When the first crossing point P_{b1}=(x_{b1}, y_{b2}) is found, φ can be computed:

$$ϕ ( {x}_{b1} , {y}_{b1} ) = arctan ( \frac{{x}_{b1}}{{f}_{t} - {y}_{b1}} ) \qquad ( 18. )$$

L and φ from Eq. 16. and 18. can than be plugged into Eq. 12. to get the backward transformation:

$${x}_{i} ( {x}_{b1} , {y}_{b1} ) = \frac{{n}_{i}}{2 {ϕ}_{max}} arctan ( \frac{{x}_{b1}}{{f}_{t} - {y}_{b1}} ) \qquad ( 19. a , b )$$

yᵢ(xₜ,yₜ,x_{b1},y_{b1},x_{b2},y_{b2})=fᵢ−(L₁+L₂+L₃)mᵢ

and finally the complete back-transformation using Eq. 9.

$${x}_{r} ( {x}_{t} , {y}_{t} , {x}_{b1} , {y}_{b1} , {x}_{b2} , {y}_{b2} ) = \frac{{n}_{rpp}}{π} arcsin ( 2 \frac{{f}_{i} - ( {L}_{1} + {L}_{2} + {L}_{3} ) {m}_{i}}{{m}_{ipp}} ) \\ {y}_{r} ( {x}_{b1} , {y}_{b1} ) = \frac{{m}_{r}}{2 {ϕ}_{max}} arctan ( \frac{{x}_{b1}}{{f}_{t} - {y}_{b1}} ) \qquad ( 20. a , b )$$

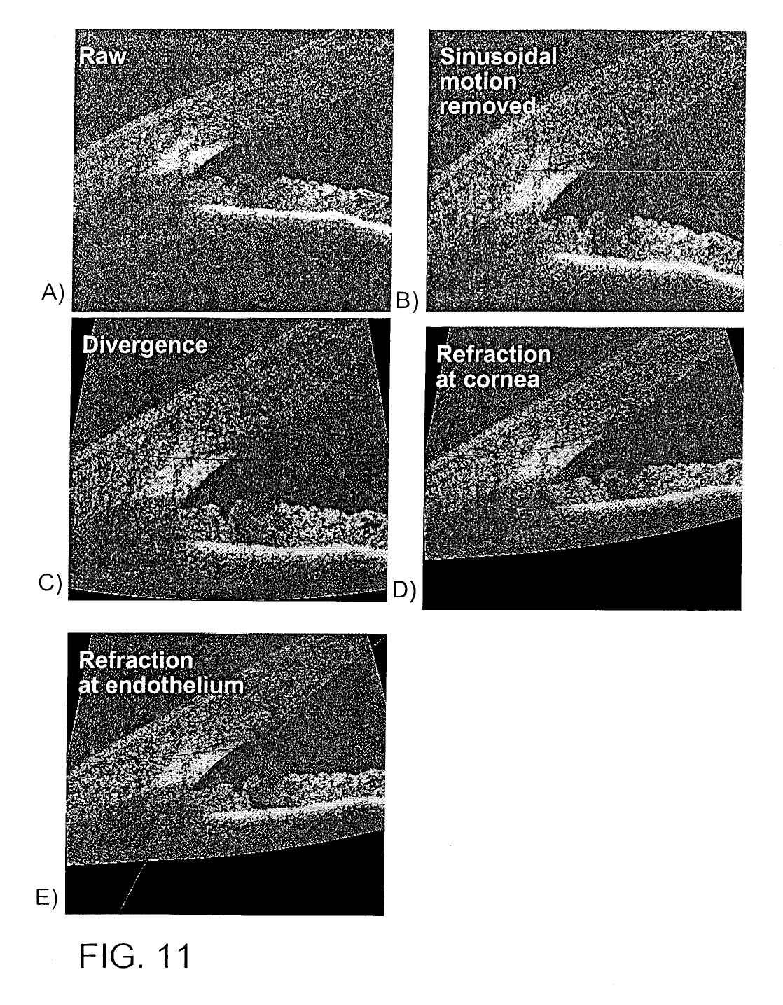

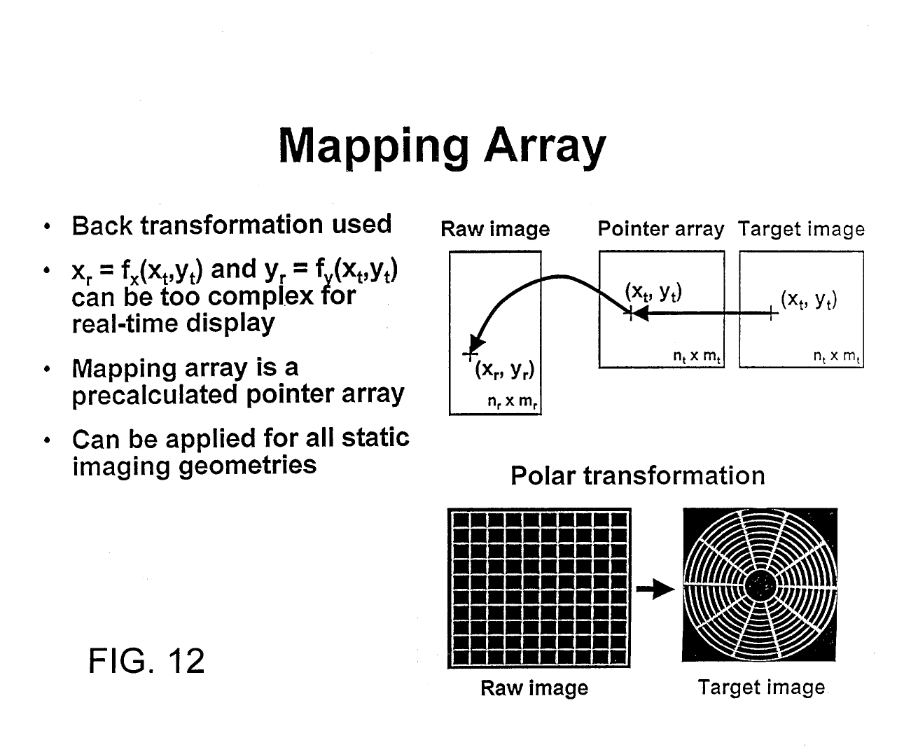

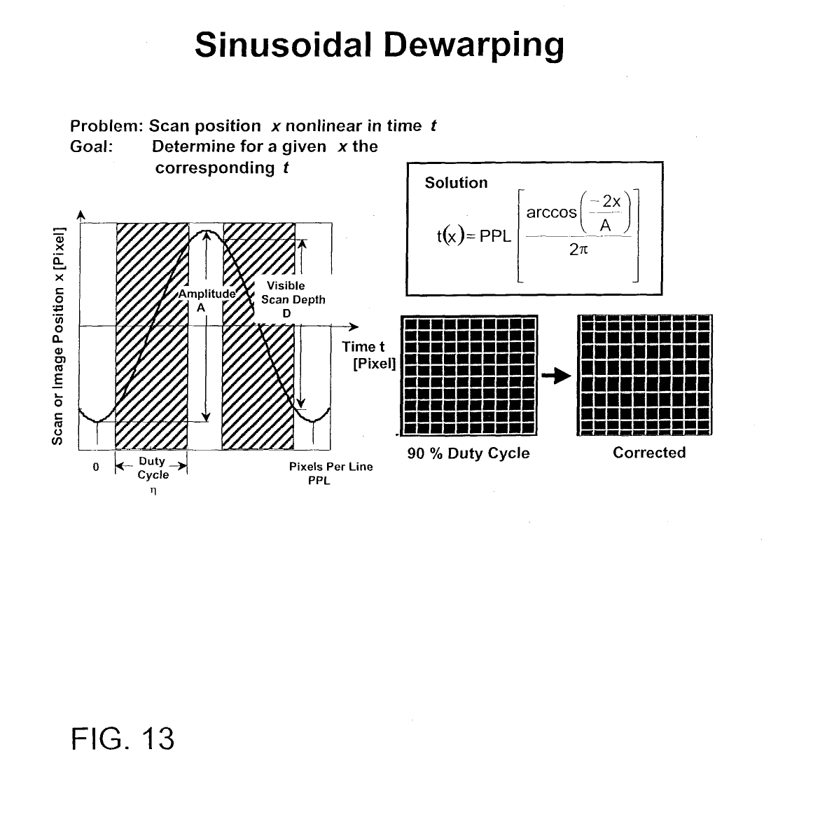

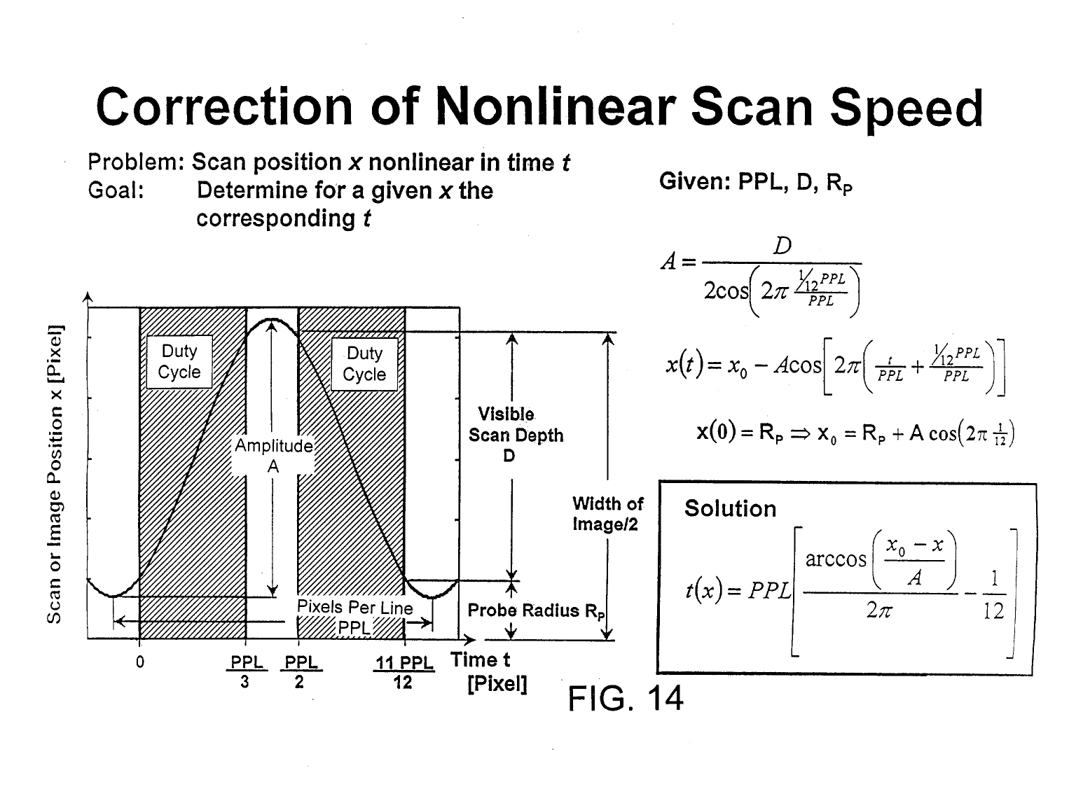

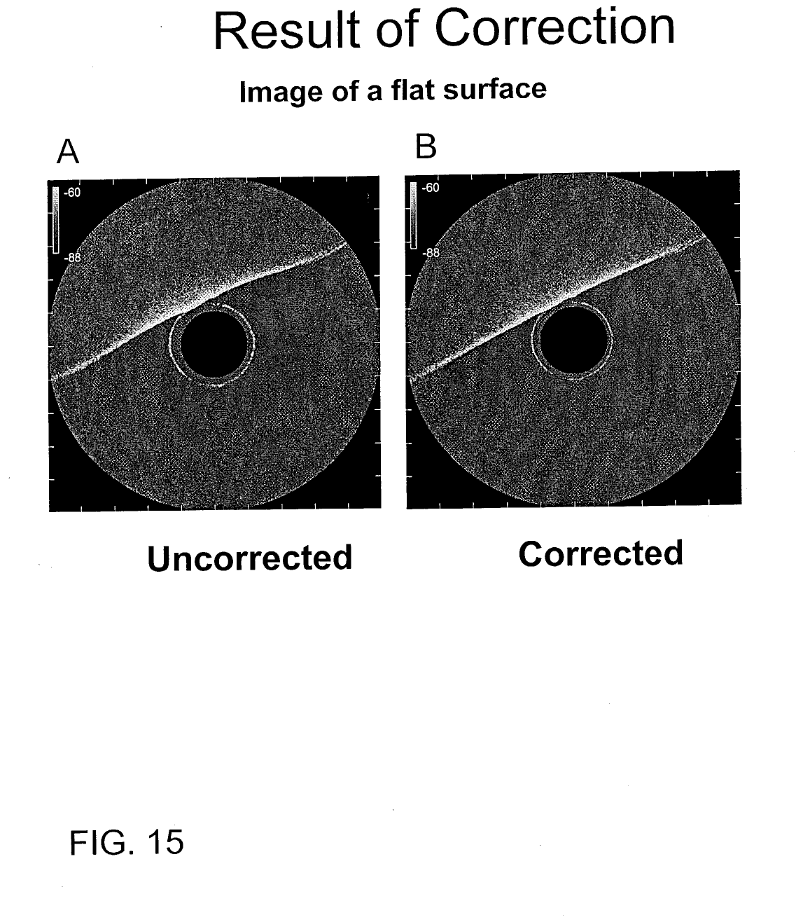

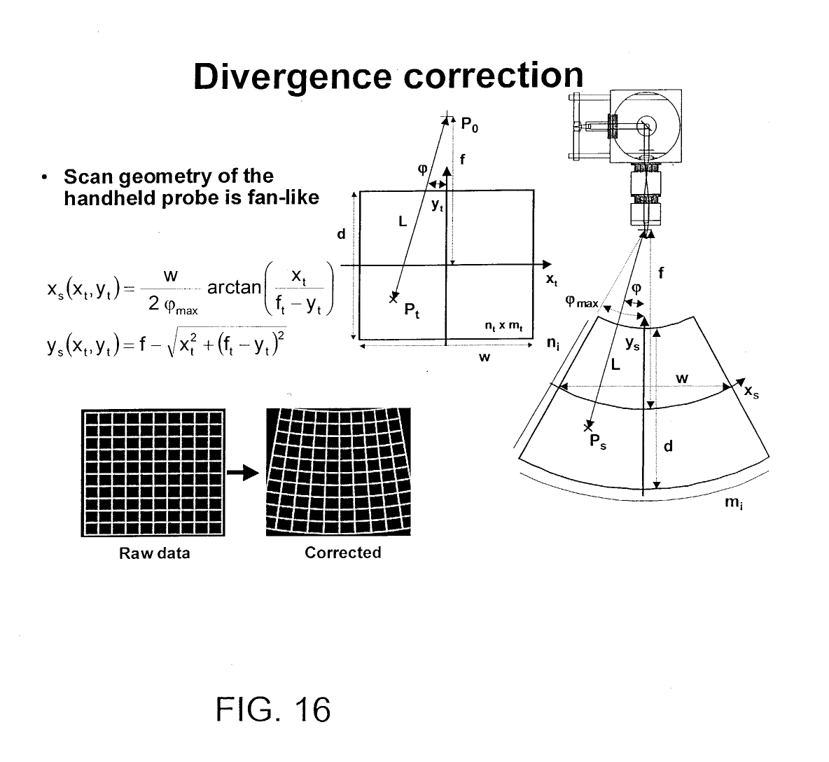

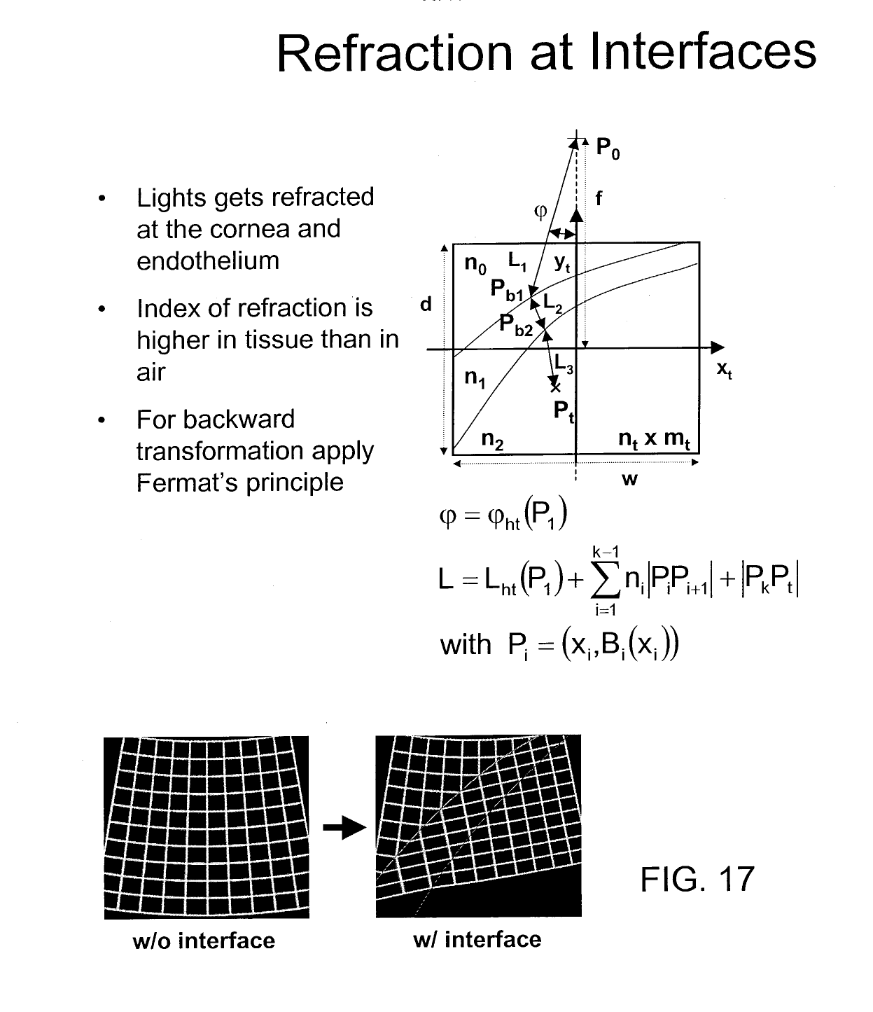

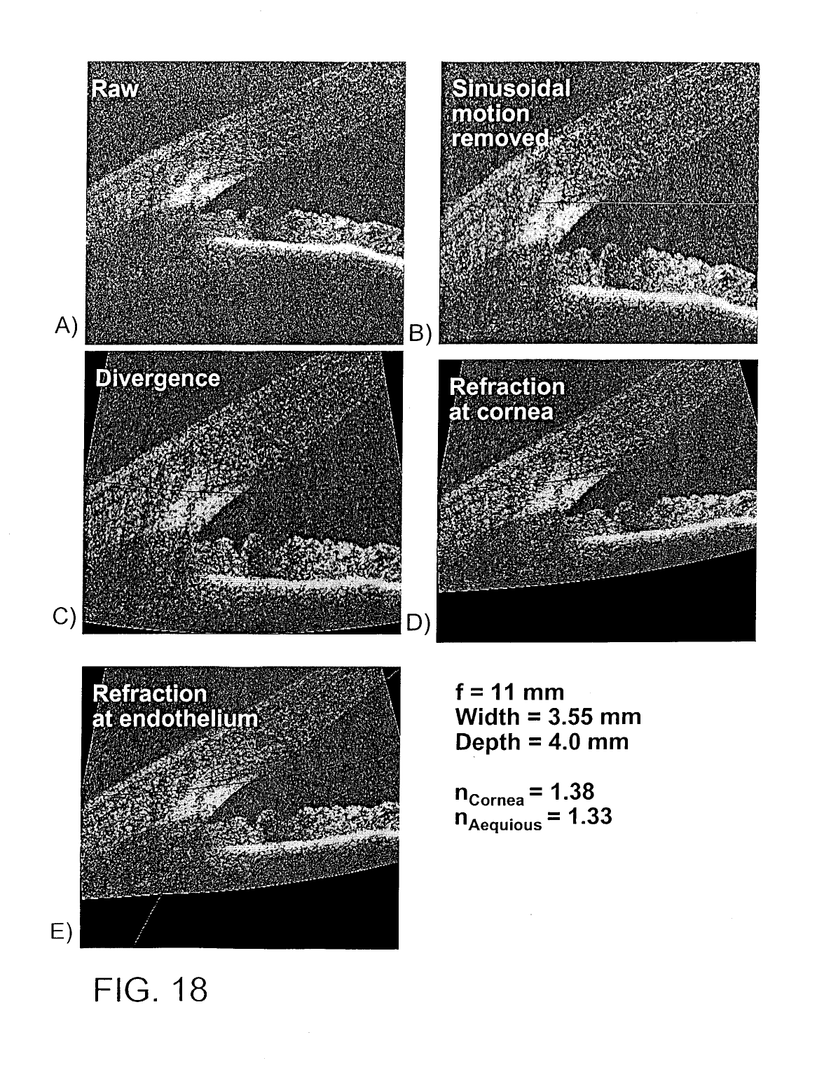

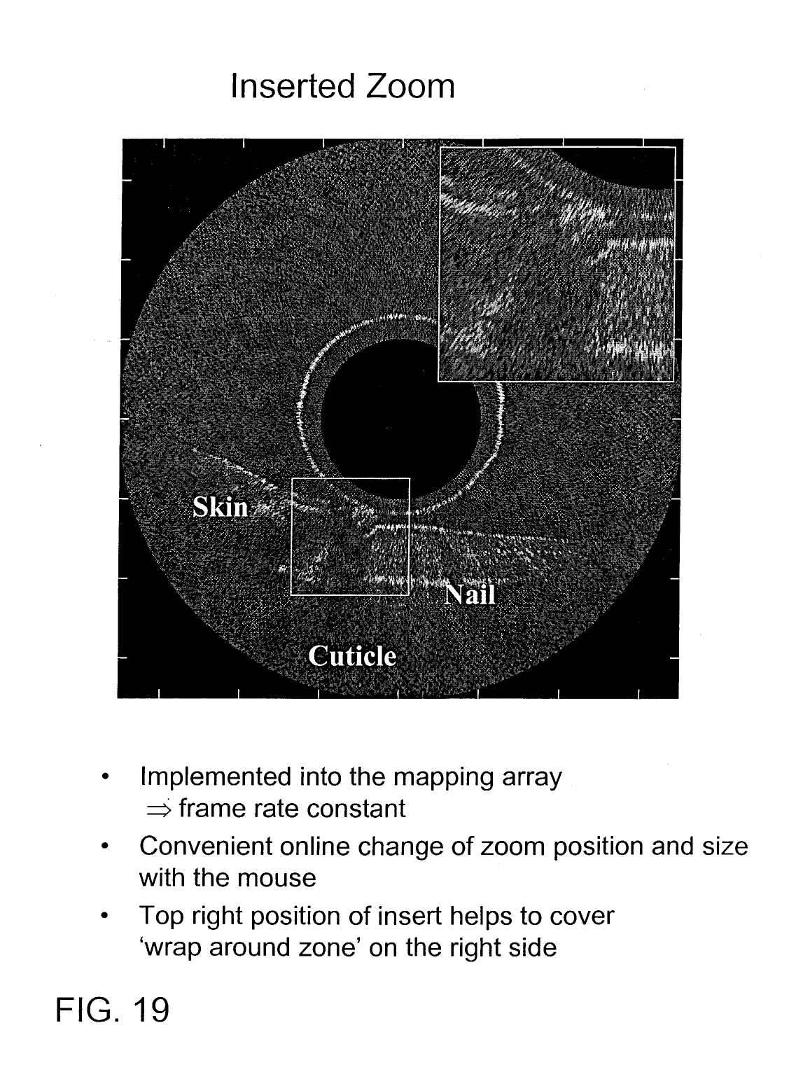

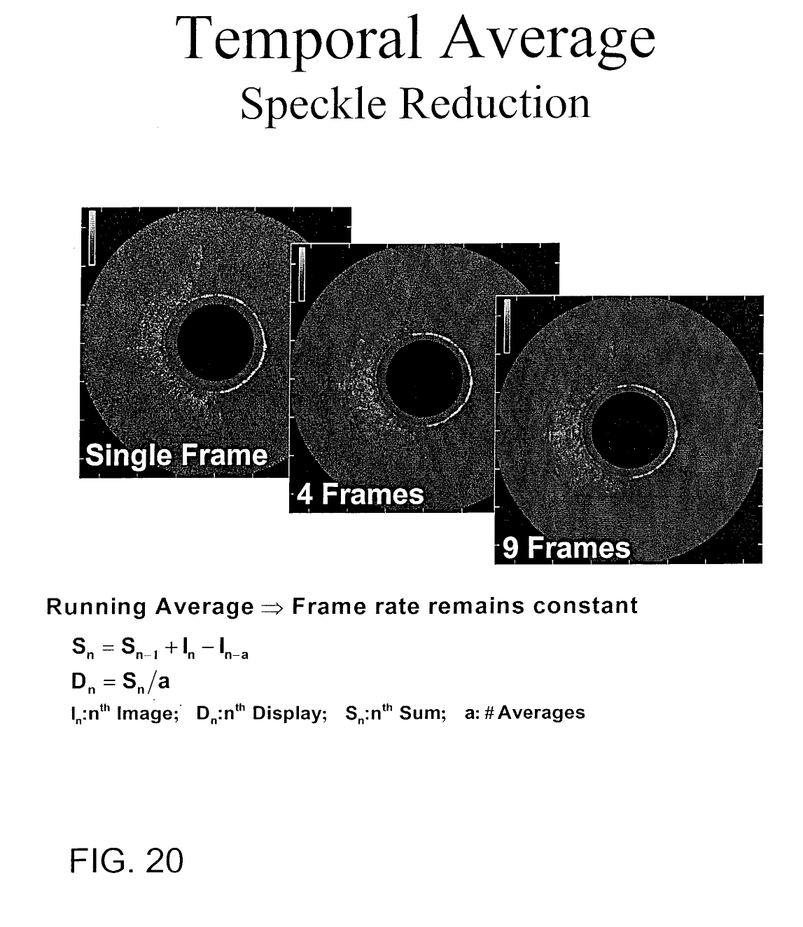

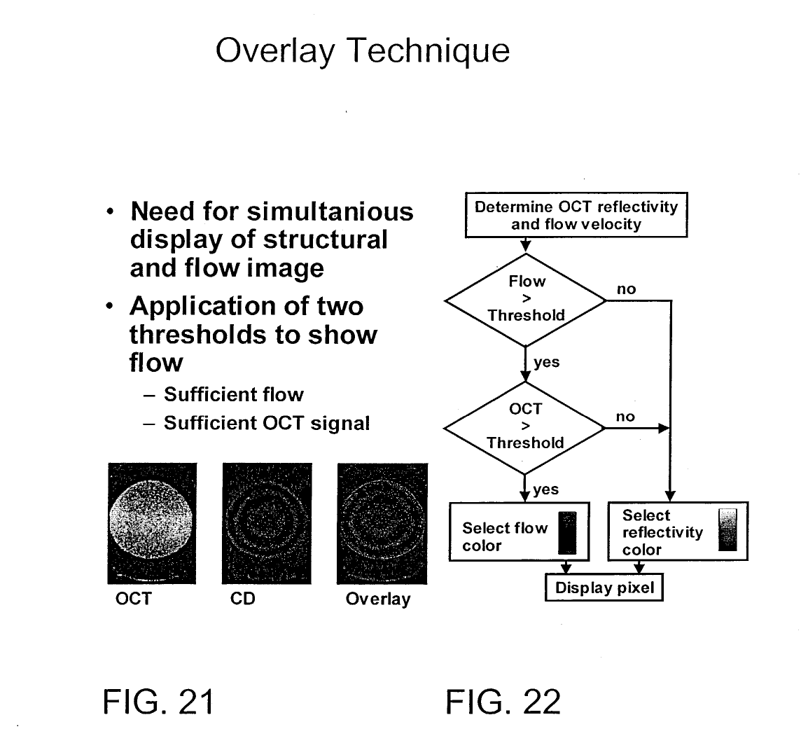

These transformations will be demonstrated in FIG. 11, using an image of the temporal anterior camber angle as an example.

References

The following references are hereby incorporated herein in their entirety.

1. Asari, K. V., S. Kumar, and D. Radhakrishnan, “A new approach for nonlinear distortion correction in endoscopic images based on least squares estimation,” Ieee Transactions on Medical Imaging 18 (4): 345-354 (1999)

2. Beiser, L., “Fundamental architectures of optical-scanning systems,” Applied Optics 34 (31): 7307-7317 (1995)

3. Drexler, W. et al., “Ultrahigh-resolution ophthalmic optical coherence tomography,” Nature Medicine 7 (4): 502-507 (2001)

4. Gronenschild, E., “The accuracy and reproducibility of a global method to correct for geometric image distortion in the x-ray imaging chain,” Medical Physics 24 (12): 1875-1888 (1997)

5. Helferty, J. P. et al., “Videoendoscopic distortion correction and its application to virtual guidance of endoscopy,” Ieee Transactions on Medical Imaging 20 (7): 605-617 (2001)

6. Hoerauf, H. et al., “First experimental and clinical results with transscleral optical coherence tomography,” Ophthalmic Surg.Lasers 31 (3): 218-222 (2000)

7. Ishikawa, H. et al., “Ultrasound biomicroscopy dark room provocative testing: A quantitative method for estimating anterior chamber angle width,” Japanese Journal of Ophthalmology 43 (6): 526-534 (1999)

8. Liu, H. et al., “Lens distortion in optically coupled digital x-ray imaging,” Medical Physics 27 (5): 906-912 (2000)

9. Mattson, P., D. Kim, and Y. Kim, “Generalized image warping using enhanced lookup tables,” International Journal of Imaging Systems and Technology 9 (6): 475-483 (1998)

10. Radhakrishnan, S., Rollins, A. M., Roth, J. E., Yazdanfar, S., Westphal, V., Bardenstein, D. S., and Izatt, J. A. Real-time optical coherence tomography of the anterior segment at 1310 nm. Achives of Ophtalmology . 2001.

11. Rollins, A. M. and J. A. Izatt, “Optimal interferometer designs for optical coherence tomography,” Opt.Lett. 24 (21): 1484-1486 (1999)

12. Rollins, A. M. et al., “In vivo video rate optical coherence tomography,” Opt.Express 3: 219-229 (1998)

13. Roth, J. E. et al., “Simplified method for polarization-sensitive optical coherence tomography,” Opt.Lett. 26 (14): 1069-1072 (1 A.D.)

14. Saxer, C. E. et al., “High-speed fiber-based polarization-sensitive optical coherence tomography of in vivo human skin,” Opt.Lett. 25 (18): 1355-1357 (2000)

15. Smith, W. E., N. Vakil, and S. A. Maislin, “Correction of distortion in endoscope images,” Ieee Transactions on Medical Imaging 11 (1): 117-122 (1992)

16. Westphal, V., Rollins, A. M., Willis, J., Sivak, M. V., Jr., and Izatt, J. A., “Histology Correlation with Endoscopic Optical Coherence Tomography,” 3919 (2000)

17. Williams, D. J. and M. Shah, “A fast algorithm for active contours and curvature estimation,” Cvgip-Image Understanding 55 (1): 14-26 (1992)

18. Xiang, J. Y. et al., “The precision improvement of the scanner in optical scanning imaging system,” Optics and Laser Technology 30 (2): 109-112 (1998)

19. Yazdanfar, S., A. M. Rollins, and J. A. Izatt, “Imaging and velocimetry of the human retinal circulation with color Doppler optical coherence tomography,” Opt.Lett. 25 (19): 1448-1450 (2000)

### CORRECTION OF IMAGE DISTORTIONS IN OCT BASED ON FERMAT'S PRINCIPLE

Optical coherence tomography (OCT) is a relatively new technology, which is capable of micron-scale resolution imaging noninvasively in living biological tissues, OCT shows rapid progress in the resolution, acquisition rate and possible applications. But one of the main advantages of OCT compared to ultrasound, non-contact imaging, also results in a ma or image distortion: refraction at the air-tissue interface. Additionally, applied scanning configurations can lead to deformed images. Both errors prevent accurate distance and angle measurements on OCT images. We describe a methodology for quantitative image correction in OCT which includes procedures for correction of non-telecentric scan patterns, as well as a novel approach for refraction correction in layered media based on Fermat's principle.

Introduction

Optical coherence tomography is a relatively new technology, which is capable of micron-scale resolution imaging noninvasively in living biological tissues. So far, the research focused on obtaining images in different applications (e.g. in ophthalmology, dermatology and gastroenterology), on resolution improvements ^{{Drexler et al. 2001}}, real-time imaging, and on functional OCT like color Doppler OCT^{{Yazdanfar et al 2000}} or polarization sensitive OCT^{{Saxer et al. 2000; Roth et al. 1 A D.}}. Meanwhile relatively little attention has been paid to image processing for quantitative image correction. Although it is relatively straightforward to use OCT to obtain accurate optical thickness measurements along a given axial scan line in a homogenous medium, there are many potential applications of OCT in which accurate two-dimensional reconstruction of complex features in layered media are required. One such application is in ophthalmic anterior segment biometry^{}Radhakrishnan et al. 2001}}, in which not only linear distances but also curvilinear surfaces, interfaces, and enclosed areas must be accurately obtained. In this field, ultrasound biomicroscopy (UBM) has proven to be a value tool for the diagnosis of appositional angle closure, which is a risk factor for progressive trabecular damage, elevated intraocular pressure and acute angle-closure glaucoma^{{Ishikawa et al. 1999}}. Since OCT is non-contact, imaging the angle with OCT^{{Radhakrishnan et al. 2001}} greatly improves patient comfort, and allows for fast screening. An additional advantage is the substantial resolution increase from 50 to 10-15 μm. Unfortunately, the non-contact mode leads to strong image distortions due to refraction at the epithelium and and to lesser extend at the endothelium of the cornea.

High lateral resolution at a convenient working distance of more the 10 mm complicates telecentric scanning. The alternatively used diverging scan-pattern results in a second source of significant image distortions. Distortions due to non-paraxial beams could be reduced in other wide-angle imaging modalities like endoscopy^{{Asari et al 1999, Helferty et at 2001; Smith et al. 1992}} or X-ray imaging^{{Gronenschild 1997, Liu et al. 2000}}.

With the methods described in this letter we are able to reduce the maximum geometric errors due to non-telecentric scanning 10-fold down to 86 μm in a 3.77×4.00 mm² image and achieve images corrected for refraction at multiple boundaries within the image applying Fermat's principle.

Methods

For display, P′=(x′,y′) in the acquired data, the raw image, has to be transformed into P=(x,y) in the target image. In principle, this can be done in forward (P=f(P′)) or backward (P′=F(P)) direction. For forward mapping the target position for a given data point is calculated. This has a key disadvantage: Since the target position will most likely be between target pixels, sophisticated algorithms have to be applied to distribute its value onto the neighboring pixels to prevent dark spots and ambiguous assigned pixels, which leads to a high computational expense. Backward mapping avoids this disadvantage by mapping each target pixel to a location in the acquired image, then using simple interpolations to obtain its value. If the backward transformation is fixed, it can be implemented with lookup table to achieve real-time imaging^{{Mattson et al. 1998}}. In the raw image, x′ and y′ denote the coordinates across and along A-scans (single depth scans). To obtain the brightest possible images with OCT, the field of view with a width w and depth d is centered a focal length f away from the lens on the optical axis.

Different scanning regimes can be differentiated, distinguished by the distance s between the pivot of the scanning beam and the final imaging lens with the focal length f (FIG. 1A). The position s′ of the image of the pivot calculates to s′=(f·s)/(s−f), given by the thin lens equation. The scanning beams are either (i) converging (s>f, s′>f+d/2), (ii) parallel (telecentric, s=f, or (iii) diverging (s<f, s′<f−d/2). The condition given for s′ avoids ambiguous assignments between raw and target image. P can also be defined in polar coordinates (φ,L), with the scanning angle φ and the distance L to a plane optically equidistance (EP) from the scanning pivot. We have arbitrarily chosen this plane to intersect the optical axis in the lens (FIG. 1). In the general case. and for a homogeneous sample (denoted by g and h), φ and L are given by

$${ϕ}_{h}^{g} ( x , y ) = arctan ( \frac{x}{{s}^{′} - ( f - y )} ) , \qquad ( 1 a , b )$$

Lₕ^{g}(x,y)=s′−{square root over (x²+(s′−(f−y))²)}

with the exception of the telecentric scan (denoted by t), where s′ goes to infinity:

$${ϕ}_{h}^{t} ( x , y ) = arctan ( \frac{x}{f - y} ) . \qquad ( 2 a , b )$$

Lₕ^{t}(x,y)=n₀\sqrt{x²+(f−y)²}

The scanning angle to reach the outsides of the field of view at the focal plane is given by

$${ϕ}_{max}^{g , t} = {ϕ}_{h}^{g , t} ( \frac{w}{2} , 0 ) . \qquad ( 3 )$$

If the sample to be imaged is non-homogeneous, refraction occurs. Additionally, depending on the index of refraction n, the geometrical pathlength differs from the optical pathlength. In the following, we assume k layers of different media in the area imaged, with the indices of refraction of nₗ to nₖ, and air on top (n₀=1). The boundaries Bₖ(x) are given as smooth functions.

The forward transformation would use Snell's law to calculate the target pixel given the raw data pixel. But for the back-transformation Fermat's principle has to be applied. It states that the light would always take the shortest path between the source and the target. The pathlength can be divided into several pieces between the points Pᵢ, where the beam crosses the boundaries, and the pathlength Lₕ^{g,t} in air. φ is only depending on the first crossing point P₁.

φ^{g,t}(P₁, . . . ,Pₖ,P)=φₕ^{g,t}(P₁)

$${L}^{g , t} ( {P}_{1 , … ,} {P}_{k} , P ) = {L}_{h}^{g , t} ( {P}_{1} ) + {\sum }_{i = 1}^{k - 1} {n}_{i} \vert {P}_{i} {P}_{i + 1} \vert + {n}_{k} \vert {P}_{k} P \vert \qquad \text{(4a, b)}$$

Pᵢ=(xᵢ,Bᵢ(xᵢ)) are a priory/initially unknown. Fermat's principle states that the path length L of the light reaching P will be minimal. Assuming no focal spots, there is a unique solution for the Pᵢ.

In the rectangular array of acquired data, the horizontal position x′ is linear with the scan angle φ′, while the equidistance plane is always a focal length away from the vertical center of the image:

$${ϕ}^{′} ( {x}^{′} {y}^{′} ) = {x}^{′} \frac{{{ϕ}^{′}}_{max}}{w / 2} \qquad \text{(5a, b)}$$

L′(x′,y′)=f−y′

Since φ^{g,t}=φ′ and L^{g,t}=L′, the complete backward transformations x′=Fₓₕ^{g,t}(P_{1, . . . ,}Pₖ,P) and y′=F_{yh}^{g,t}(P_{1,} . . . ,Pₖ,P) can be obtained from Eqs. (4), (5), assuming that φₘₐₓ^{g,t}=φₘₐₓ′:

Fₓₕ^{g,t}(P₁, . . . ,Pₖ,P)=f−L^{g,t}(P₁, . . . ,Pₖ,P)

$${F}_{yh}^{g , t} ( {P}_{1 , … ,} {P}_{k} , P ) = \frac{w}{2 {ϕ}_{max}^{g , t}} {ϕ}_{h}^{g , t} ( {P}_{1} ) \qquad ( 6 )$$

The high speed OCT interferometer employed in this letter was based on a previously published design^{{Rollins et al. 1998}}, with a Fourier-domain rapid-scanning reference arm (RSOD) including a resonant scanner oscillating at f_{scan}=2 kHz. In the sample arm, we used a versatile lateral scanning hand held probe with a divergent scan (FIG. 1Aiii) and a focal depth of 11.4 mm. This scanner was chosen for the best trade off between smallest focal spot sizes and large working distance for high patient comfort. The central image size was 3.77 mm wide and 4 mm deep (in air). A broadband (λ=1.32 μm, Δλ=68 nm, FWHM), high power (22 mW) semiconductor optical amplifier light source was used to illuminate the interferometer. For improved SNR, we used an efficient, optical circulator-based approach with balanced detection^{{Rollins et al. 1999}}. The images were preprocessed to remove the distortion form the nonlinear movement of the resonant scanner^{{Westphal et al. 2000}}(36 μm maximum residual error). We imaged a test object and the temporal angle in the anterior segment of the eye of a healthy volunteer. All images were acquired at 8 frames/s to reduce motion artifacts.

The transformations derived above were implemented using MatLab 5.2™ and applied offline to the acquired images in the following steps: First the geometric distortion was removed, therefore the first boundary could be distortion-free defined semi-automatically by user input of 4 to 6 points on the boundary and refined by active contours^{{Williams et al. 1992}}. Second, after the correction of refraction at the first boundary, the second boundary was also distortion-free and could be defined. This scheme of defining boundaries and dewarping was continued until the image was completely dewarped. All intermediate and the final target image always referred to the raw image data for minimum blurring due to the bilinear interpolation utilized.

Since Fermat's principle has to be done for every pixel in the target image, this can be computational intensive if no previous knowledge is employed. We greatly improved the performance by assuming that the Pᵢ for a given pixel in a row will only vary slightly from the Pᵢ's of the same pixel in the row before. Starting out with the previous Pᵢ's, their xᵢ were first varied in steps of 0.5 pixels in a range of ±2.5. For the optimum path this was refined in a second iteration to a resolution of 0.1 pixels.

Results

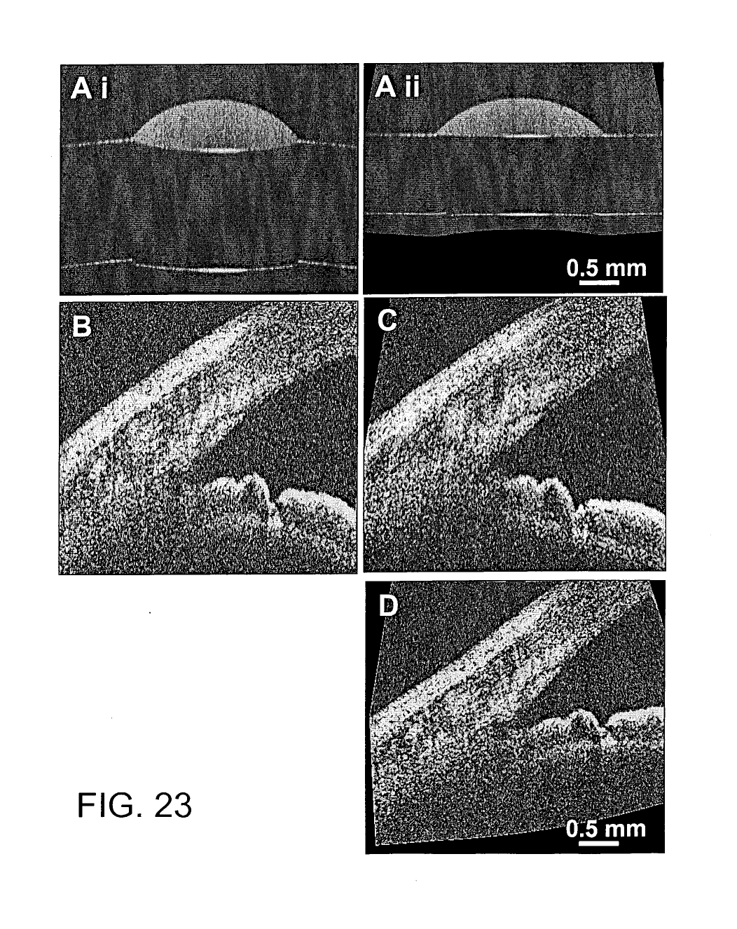

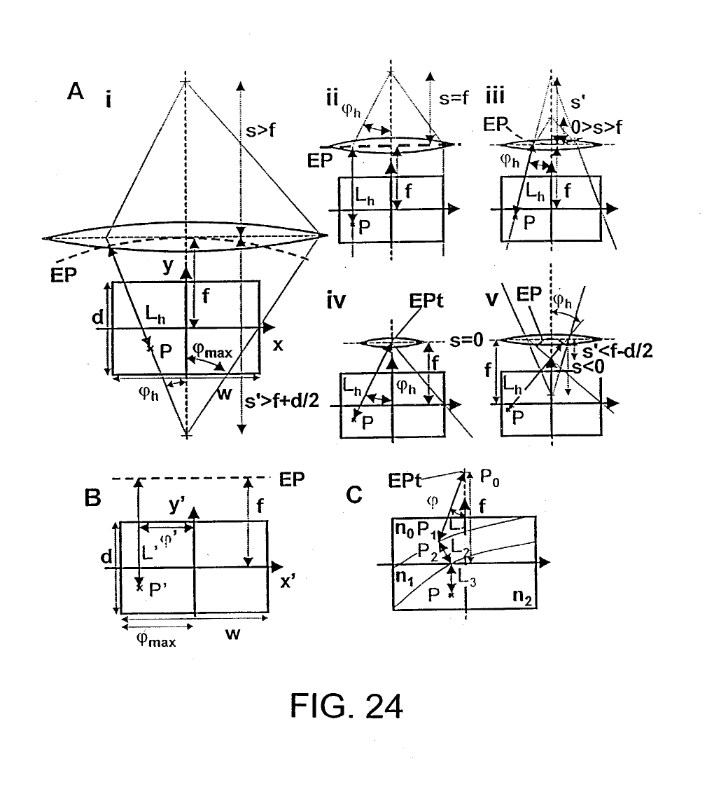

As a first test object, we used a cover slip (975 μm, n₂=1.52), placed on a piece of paper, with an Intralipid© drop (n₁=1.33) on top. FIG. 23Ai shows several distortions: (1) the boundaries of the flat cover slip appeared bend, due to the geometric distortion of the diverging scanner, and (2) under the drop the cover slip appeared to be bent down, both on the upper and lower surface, because the optical pathway to the bottom of the drop is longer than the physical. Maximum deviation from the flat surface was 53 and 67 μm, but both effect partially compensated each other. (3) The cover slip showed up thicker than it physically was. Refiaction was not obviously visible. After the correction, both cover slip surfaces were flat with a maximum error of 22 respectively 15 μm, the thickness of the cover slip was measured 963 μm (FIG. Aii). Since the probe was hand-held, there is a remaining tilt due to non-normal positioning of the probe. Due to the highly positive curvature at the edges of the drop, two wedge-shaped areas are visible below, where the

Snell's more sensitive to non-smoothness of boundaries (if beam hits at locally step portion of b., the beam goes elsewhere), while Fermat's principle searches for absolute minimum

What is claimed is:

1. A method for determining a condition of a tissue sample, comprising the steps of:
generating at least one light beam;
splitting the light beam into at least one measuring light beam and at least one reference light beam;
directing the measuring light beam into a tissue sample;
adjusting a relative optical path between the reference light beam and the measuring light beam;
bringing the measuring light beam scattered back by the tissue sample into an interference relationship with the reference light beam; and
processing the interferometric signal to determine a condition of the tissue sample.

2. A system for determining a condition of a tissue sample, comprising:
light generating means for generating at least one light beam;
beam splitter means for splitting up said light beam into at least one measuring light beam and at least one reference light beam;
adjusting means for adjusting a relative optical path between the measuring light beam and the reference light beam;
directing means for directing the measuring light beam into the tissue sample;
detection means for receiving light scattered back from the measuring light beam by the tissue sample;
means for interferometrically superimposing the back-scattered measuring light beam and the reference light beam; and
processing means for processing the interferometrically superimposed signal.

3. Correction of multiple image distortions in real-time in OCT based on Fermat's principle and mapping arrays.
